(19) United States
(12) Patent Application Publication
(10) Pub. No.: US 2026/0276475 A1
(43) Pub. Date: Sep. 17, 2026

(54) Methods and Apparatus for Performing a Wing Bend Test

(71) Applicant: REGENT Craft Inc., North Kingstown, RI (US)

(72) Inventors: William Bryan Baker, North Kingstown, RI (US); Sam Fitzgerald, North Kingstown, RI (US); Paul Kuechler, North Kingstown, RI (US)

(21) Appl. No.: 19/566,943

(22) Filed: Mar. 13, 2026

Related U.S. Application Data
(60) Provisional application No. 63/772,444, filed on Mar. 14, 2025.

(51) Int. Cl. G01M 5/00; B64F 5/60

(52) U.S. Cl. CPC G01M 5/0016; B64F 5/60; G01M 5/005

(57) ABSTRACT

A method for performing a wing bend test on a vehicle wing may involve: (i) positioning a plurality of inflatable bags underneath an underside of the wing, wherein each of the plurality of inflatable bags is configured to, when inflated, apply an upward force to the wing, (ii) installing measurement tools for measuring parameters of the wing bend test, wherein at least one of the parameters includes an upward force applied by the plurality of inflatable bags on the wing, (iii) for each of the plurality of inflatable bags, controlling a pressure of the inflatable bag via a pressure control system, (iv) utilizing at least one of the measurement tools, measuring the upward force applied by the plurality of inflatable bags on the wing, and (v) based on an evaluation of the measured upward force, adjusting the pressure of at least one of the plurality of inflatable bags.

### CROSS-REFERENCE TO RELATED APPLICATIONS

This application claims the benefit of priority under 35 U.S.C. § 119 to U.S. Provisional Patent App. No. 63/772,444, filed on Mar. 14, 2025, which is incorporated herein by reference in its entirety.

### BACKGROUND

Vehicle wings must be able to safely withstand a wide range of forces throughout their operational life. For instance, during operation, wings experience complex bending moments and shear loads generated by lift, fuel weight, engine loads, wind conditions, etc. Ensuring that a vehicle's wing is able to maintain its structural integrity during the wing's operational life is critical to ensuring the safety of the vehicle and its passengers.

To test a wing's ability to maintain its structural integrity during normal operation, the wing—which is typically detached from the vehicle during such a test—is exposed to various forces in a controlled environment to simulate lift forces that the wing may experience during operation. As the forces are being applied to the wing, the wing's performance is measured to verify that its structural integrity is maintained. This may generally be referred to as a wing bend test.

### OVERVIEW

Aspects described herein are related to a new approach for performing wing bend tests for vehicle wings.

In one aspect, disclosed herein is a method for performing a wing bend test on a vehicle wing, the method comprising: (i) positioning a plurality of inflatable bags underneath an underside of the wing, wherein each of the plurality of inflatable bags is configured to, when inflated, apply an upward force to the underside of the wing, (ii) installing one or more measurement tools for measuring one or more parameters of the wing bend test, wherein at least one of the one or more parameters includes an upward force applied by the plurality of inflatable bags on the wing, (iii) for each of the plurality of inflatable bags, controlling a pressure of the inflatable bag via a pressure control system, (iv) utilizing at least one of the one or more measurement tools, measuring the upward force applied by the plurality of inflatable bags on the wing, and (v) based on an evaluation of the measured upward force applied by the plurality of inflatable bags on the wing, adjusting the pressure of at least one of the plurality of inflatable bags.

In some embodiments, the pressure control system may take various forms. In some implementations, the pressure control system may take the form of an air-based pressure control system including an air manifold and a plurality of gate valves, wherein each of the plurality of gate valves is configured to control an air pressure for a respective one of the plurality of inflatable bags. In other implementations, the pressure control system may take the form of a liquid-based pressure control system including a water column connected to the inflatable bag via a water hose. In implementations where the pressure control system takes the form of a liquid-based pressure control system, the functionality of controlling the pressure of the inflatable bag via the liquid-based pressure control system may involve controlling the pressure of the inflatable bag by adjusting a height of water in the water column.

Further, in some embodiments, the wing may be anchored to a testing fixture during the wing bend test.

Further yet, in some embodiments, the wing may be attached to a vehicle during the wing bend test.

Further yet, in some embodiments, the upward force applied by the plurality of inflatable bags on the wing may take various forms. In some implementations, the upward force applied by the plurality of inflatable bags on the wing may take the form of an evenly distributed upward force. In other implementations, the upward force applied by the plurality of inflatable bags on the wing may take the form of an unevenly distributed upward force that simulates an elliptical load distribution that the wing is likely to experience during operation.

Further yet, in some embodiments, the one or more measurement tools may include at least one of (i) a plurality of scales positioned beneath the plurality of inflatable bags, wherein each of the plurality of scales is configured to measure a total vertical force exerted by a corresponding one of the plurality of inflatable bags, (ii) a set of load pins coupling the wing to a testing fixture or a vehicle, or (iii) a set of load cells.

Further yet, in some embodiments, an interface layer including a soft layer and a rigid layer may be positioned between each of the plurality of inflatable bags and the wing.

Further yet, in some embodiments, the one or more measurement tools may include a fiber optic strain sensor (FOSS), and the method may further involve (i) utilizing the FOSS to measure strain along a length of the wing.

Further yet, in some embodiments, the pressure control system may include a plurality of safety relief valves, and the method may further involve (i) implementing the plurality of safety relief valves to present over-pressurization of the plurality of inflatable bags.

Further yet, in some embodiments, the wing bend test may take the form of (i) a static wing bend test or (ii) a dynamic fatigue test.

Further yet, in some embodiments, the method may further involve utilizing a graphical user interface (GUI) system to present, via a display of the GUI system, real-time force measurements from at least one measurement tool, wherein the GUI system is communicatively coupled to the at least one measurement tool.

In another aspect, disclosed herein is an apparatus for performing a wing bend test on a vehicle wing, the apparatus including: (i) a test fixture configured to secure the wing, (ii) a plurality of inflatable bags configured to be positioned beneath an underside of the wing, (iii) one or more measurement tools for measuring one or more parameters of the wing bend test, wherein at least one of the one or more parameters includes an upward force applied by the plurality of inflatable bags on the wing, (iv) a pressure control system configured to control pressure within the plurality of inflatable bags, and (v) a graphical user interface (GUI) system communicatively coupled to the one or more measurement tools, wherein the GUI system is configured to receive real-time force measurements from at least one measurement tool and display the real-time force measurements.

In some embodiments, the test fixture may include a plurality of concrete barriers to secure the wing.

Further, in some embodiments, the apparatus may also include at least one of (i) a fiber optic strain sensor (FOSS) configured to be installed on the wing to measure strain of the wing or (ii) at least one load pin configured to connect the wing to the testing fixture and measure vertical reaction forces.

Further yet, in some embodiments, the apparatus may also include an interface layer comprising (a) a soft layer and (b) a rigid layer, wherein the interface layer is positioned between each of the plurality of inflatable bags and the underside of the wing.

Further yet, in some embodiments, the pressure control system may include (a) an air-based pressure control system including an air manifold and a plurality of gate valves, wherein each of the plurality of gate valves is configured to control an air pressure for a respective one of the plurality of inflatable bags or (b) a liquid-based pressure control system including a water column connected to the inflatable bag via a water hose, wherein the liquid-based pressure control system is configured to control the pressure of the plurality of inflatable bags by adjusting a height of water in the water column.

Further yet, in some embodiments, the upward force applied by the plurality of inflatable bags on the wing may include (a) an evenly distributed upward force or (b) an unevenly distributed upward force that simulates an elliptical load distribution that the wing is configured to experience during operation.

One of ordinary skill in the art will appreciate these as well as numerous other aspects in reading the following disclosure.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1A depicts a perspective view of a craft, according to an example of the present disclosure.

FIG. 1B depicts a top view of a craft, according to an example of the present disclosure.

FIG. 1C depicts a side view of a craft, according to an example of the present disclosure.

FIG. 1D depicts a front view of a craft, according to an example of the present disclosure.

FIG. 1E illustrates a perspective view of an example of a craft, according to an example of the present disclosure.

FIG. 1F illustrates a perspective view of an example of a craft, according to an example of the present disclosure.

FIG. 1G illustrates a perspective view of an example of a craft, according to an example of the present disclosure.

FIG. 2A illustrates an example main hydrofoil deployment system of a craft, according to an example of the present disclosure.

FIG. 2B illustrates an example main hydrofoil deployment system of a craft, according to an example of the present disclosure.

FIG. 2C illustrates an example hydrofoil assembly, according to an example of the present disclosure.

FIG. 3 illustrates an example rear hydrofoil deployment system of a craft, according to an example of the present disclosure.

FIG. 4 depicts an example battery system of a craft, according to an example of the present disclosure.

FIG. 5 depicts an example control system of a craft, according to an example of the present disclosure.

FIG. 6A depicts a craft in a hull-borne mode of operation, according to an example of the present disclosure.

FIG. 6B depicts a craft in a hydrofoil-borne maneuvering mode of operation, according to an example of the present disclosure.

FIG. 7A depicts a craft in a hydrofoil-borne takeoff mode of operation, according to an example of the present disclosure.

FIG. 7B is a graph that depicts various lift forces acting on a craft, according to an example of the present disclosure.

FIG. 8 depicts a craft in a wing-borne mode of operation, according to an example of the present disclosure.

FIG. 9 depicts an example of an existing whiffle tree for performing wing bend tests.

FIG. 10 depicts an example wing and plurality of inflatable bags for performing wing bend tests in accordance with the present disclosure.

FIG. 11 depicts an example inflatable bag that may be utilized to apply an upward force to a wing in accordance with the present disclosure.

FIG. 12 depicts a plurality of inflatable bags positioned along the length of a wing for applying an upward force to the wing in accordance with the present disclosure.

FIG. 13 depicts an example air-based pressure control system for controlling the pressure of a plurality of inflatable bags in accordance with the present disclosure.

FIG. 14 depicts an example air manifold that may be utilized to implement the air-based pressure control system of FIG. 13 in accordance with the present disclosure.

FIG. 15 depicts an example liquid-based pressure control system for controlling the pressure of a plurality of inflatable bags in accordance with the present disclosure.

FIG. 16 depicts an example plurality of load cells for measuring the upward force applied to a wing by a plurality of inflatable bags in accordance with the present disclosure.

FIG. 17 depicts an example load pin for measuring the upward force applied to the wing in accordance with the present disclosure.

FIG. 18 depicts an example graphical user interface (GUI) for viewing measurements and possibly controlling various components of an apparatus for performing wing bend tests in accordance with the present disclosure.

FIG. 19 depicts an illustration of bag deformation that may occur during wing bend tests in accordance with the present disclosure.

FIG. 20 depicts an illustration of a tensioning element that may be utilized to manage bag deformation, in accordance with the present disclosure.

FIG. 21 depicts an illustration of a cap element that may be utilized to manage bag deformation, in accordance with the present disclosure.

FIG. 22 depicts a flow chart illustrating example functionality that may be carried out in accordance with the present disclosure.

FIG. 23 depicts another flow chart illustrating example functionality that may be carried out in accordance with the present disclosure.

FIG. 24 depicts a structural diagram of an example computing platform that may be configured to carry out one or more of the functions, in accordance with aspects of the disclosed technology.

FIG. 25 depicts a structural diagram of an example client device that may be configured to communicate with the example computing platform of FIG. 24 and also carry out one or more functions, in accordance with aspects of the disclosed technology.

The drawings are for the purpose of illustrating example embodiments, and it is to be understood that the present disclosure is not limited to the arrangements and instrumentalities shown in the drawings.

### DETAILED DESCRIPTION

Various examples of systems, devices, and/or methods are described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

In the figures, like numerals can refer to like elements throughout the figures.

### I. Introduction

Aspects described herein are generally related to craft, such as aircraft, including craft that are capable of taking off from, and landing on, water. Examples of such craft include crafts having extendible hydrofoils attached to the hull of the craft. For instance, a first (or “rear”) hydrofoil may be positioned towards the tail section of the craft, and a second (or “main”) hydrofoil may be positioned near the midsection of the craft, forward the first hydrofoil (e.g., proximate to the main wing of the craft). The hydrofoils may be controlled to extend and retract depending on the operating mode of the craft. For example, when airborne, the hydrofoils may be retracted towards the hull, and when hull-borne or foil-borne, the hydrofoils may be extended. The term “hull” is used throughout this description to refer to the main body of the craft. It is understood that this term is interchangeable with the term “fuselage,” among other possible terms, which is sometimes used to refer to the main body of aircraft. Further, the terms “craft” and “vehicle” are also understood to be interchangeable.

In some examples, the craft may additionally or alternatively be a wing-in-ground (WIG) effect craft. Such craft fly close to the ground or water surface by using the ground effect principle, where flying close to the surface reduces aerodynamic drag and increases lift. For example, the drag on the craft is reduced when its distance from the ground is within about the length of the aircraft's wingspan.

Aspects described herein are related to a new approach for performing wing bend tests for vehicle wings, as well as a corresponding apparatus for performing said wing bend tests according to the new approach. Vehicle wings must be able to safely withstand a wide range of forces throughout their operational life. For instance, during operation, wings experience complex bending moments and shear loads generated by lift, fuel weight, engine loads, wind conditions, etc. Ensuring that a vehicle's wing is able to maintain its structural integrity during the wing's operational life is critical to ensuring the safety of the vehicle, as well as the passengers of the vehicle. To test a wing's ability to maintain its structural integrity during normal operation, the wing—which is typically detached from the hull of the vehicle during such a test—is exposed to various forces in a controlled environment to simulate the lift forces experienced during operation. As the forces are being applied to the wing, the wing's performance is measured to verify that its structural integrity is maintained. This may generally be referred to as a wing bend test. Existing approaches for performing wing bend tests often employ “whiffle trees” or hydraulic actuators to apply the necessary forces to the wing. However, these approaches are known to be imprecise, in addition to being highly complex, resource-intensive, and logistically burdensome. Additionally, these approaches often necessitate hardpoints on the wing structure to apply loads. However, many contemporary wing designs do not include hardpoints, particularly wing designs with delicate skins. Further, point-loading—a common characteristic of these existing approaches—can induce damage to such sensitive structures. Further yet, it is exceptionally expensive to fabricate and set up the custom jigs and rigs that are utilized in these existing approaches, often running into the millions of dollars and requiring extensive lead times. Existing approaches also often require the wing to be suspended in the air during testing, which creates a risk that the wing may fall during testing-causing damage to the wing and the testing equipment, among other possibilities. Further, it may be desirable to test the structural integrity of a wing by exposing the wing to forces outside of those expected to be experienced by the wing during regular operation. However, existing approaches are ill-equipped to providing these types of tests, as the equipment (e.g., metal attachment points) utilized by existing approaches are prone to wear out and potentially break during these types of tests, as well as at other times.

Existing solutions, including whiffle trees, are not adequate for performing wing bend tests for some wings. For instance, some wings may comprise a single structural spar manufactured from carbon fiber over a foam core. The inherent design characteristics of such a wing-including, for example, a relatively thin outer skin and a lack of readily available hardpoints-underscore the limitations of traditional approaches for performing wing bend tests and highlight the critical need for a more adaptable, cost-effective, and precise solution.

Disclosed herein is a new approach for performing wing bend tests that fundamentally addresses the shortcomings of existing approaches. At a high level, the new approach involves (i) anchoring a wing, either to a vehicle (e.g., keeping the wing installed on the vehicle) or to a test fixture (e.g., a rig or some other anchoring component), such as when the wing is detached from the vehicle, (ii) strategically positioning a plurality of inflatable, fluid-filled (e.g., gas-filled and/or liquid-filled) bags beneath the underside of a wing, and (iii) controlling the internal pressure of the plurality of inflatable bags, thereby controlling an amount of distributed upward force that is applied across the wing's length. The level of control afforded by the disclosed approach may allow for tailored forces to be applied at specific points along the length of the wing, such as the application of specific shear forces at specific points along the wing, as well as a specific moment at the root of the wing, a specific deflection of the wing, etc. By controlling the distributed upward force that is applied across the wing's surface, the disclosed approach effectively simulates the lift forces experienced during operation. Further, the disclosed approach also allows for lift forces other than those likely to be experienced during operation to be simulated, e.g., for testing the structural integrity of the wing, among other things. The disclosed approach may employ various techniques for controlling the internal pressure of the plurality of inflatable bags, including air-only techniques and possibly liquid-based techniques that involve partially filling the inflatable bags with water (or some other liquid), which may allow for more precise pressure control.

According to the disclosed approach, monitoring the wing during the wing bend test may involve monitoring various parameters of the wing bend test, which may take various forms. One parameter of the wing bend test may include the distributed upward force applied to the wing by the plurality of inflatable bags. Another parameter of the wing bend test may include the strain along the length of the wing. Various other parameters may also exist. The details of the new approach for performing wing bend tests are described in greater detail below.

The disclosed approach for performing wing bend tests improves over existing approaches in various ways.

First, the disclosed approach may be utilized to perform wing bend tests in a much more economical and convenient manner compared to traditional whiffle tree systems or hydraulic actuators, which demand multi-million dollar investments and prolonged development cycles. The components utilized by the disclosed approach are less expensive and more readily procurable than the components utilized in traditional whiffle tree systems or hydraulic actuators.

Second, the disclosed approach is inherently less complex and imposes a lighter logistical burden compared to existing setups. The use of inflatable bags to perform wing best tests removes the need for specialized hard connections to the delicate wing skin and significantly reduces the number of complex moving parts and actuators.

Third, the disclosed approach involves applying a representative distributed load across the wing surface via a plurality of inflatable bags that are strategically positioned at various locations along the length of the wing—in contrast to existing approaches, which often apply force at discrete load points via hard connections. This fundamental difference prevents localized damage to the delicate wing skin, which is a common risk with point-loading methods or hydraulic actuators.

Fourth, the disclosed approach allows for more precise control over wing bend tests than what is possible using existing approaches. For instance, as described in greater detail below, the disclosed approach allows for high levels of precision for controlling the internal pressure of the plurality of inflatable bags—which is particularly crucial for low-pressure applications, where small changes in pressure may increase the risk of damage to the wing. By allowing for high levels of precision, the disclosed approach minimizes test uncertainty and reduces the risk of damaging the wing due to misapplied pressure and the like.

Fifth, the disclosed approach may be highly adaptable to various wing shapes and sizes through the customization of bag dimensions and pressure profiles. In line with the discussion above, the disclosed approach may be employed whether the wing is attached to the vehicle's hull or detached from the hull (e.g., and secured within a dedicated test frame). This flexibility extends the new approach's utility across different stages of vehicle development and testing.

The disclosed approach improves over existing approaches for performing wing bend tests in other ways as well.

A description of example Wing-In-Ground Effect Vehicles is given below. While the disclosed approach for performing wing bend tests may at times be described with respect to the wings of such Wing-In-Ground Effect Vehicles, it should be noted that the disclosed approach for performing wing bend tests is not limited to such, and may be utilized for any manner of wing for any manner of vehicle.

### II. Example Wing-In-Ground Effect Vehicles

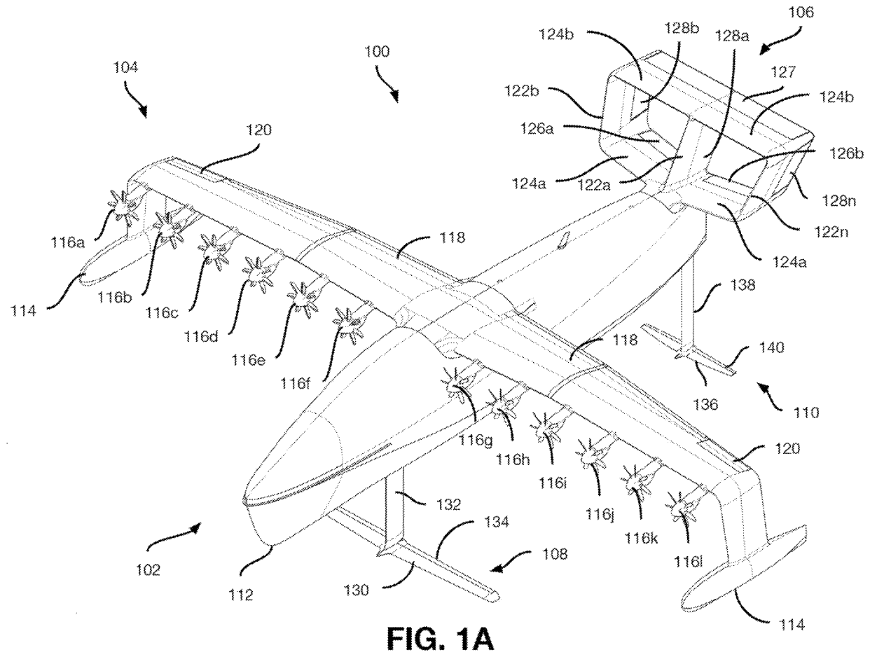

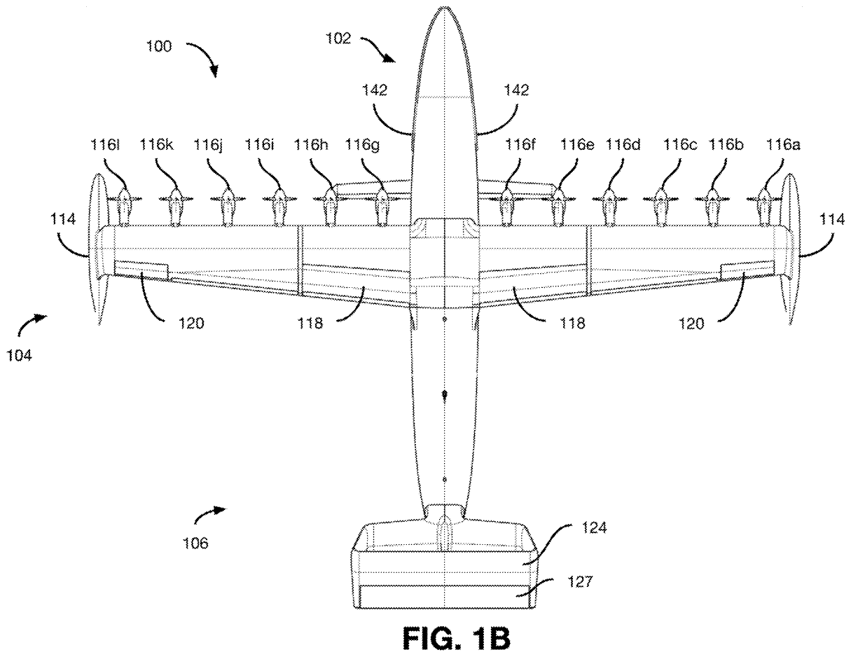

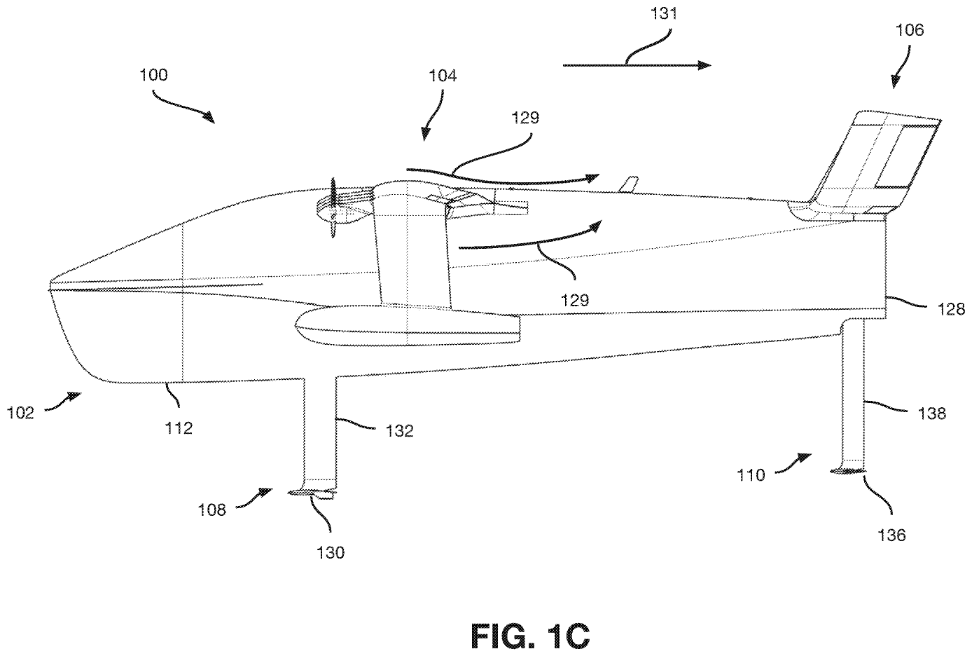

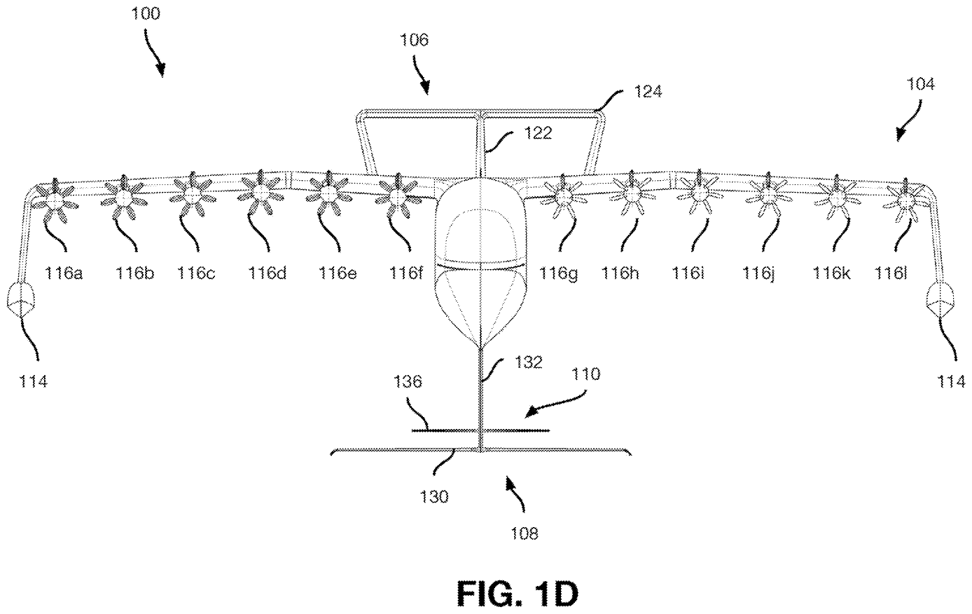

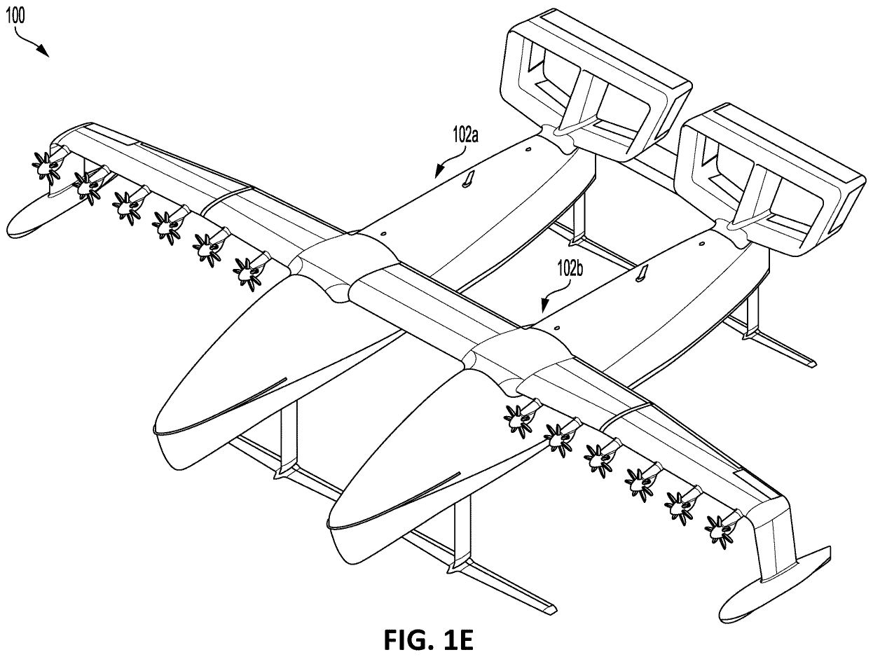

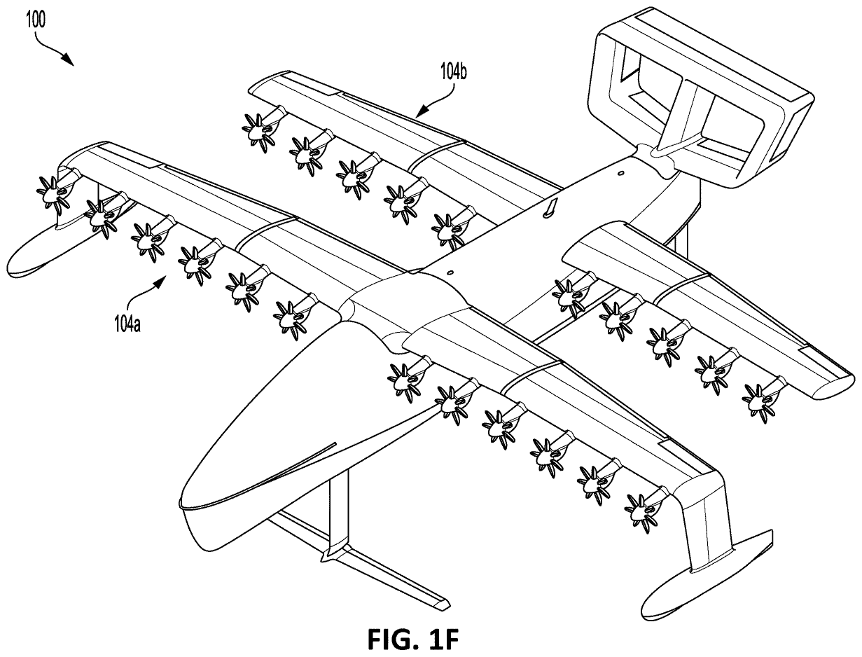

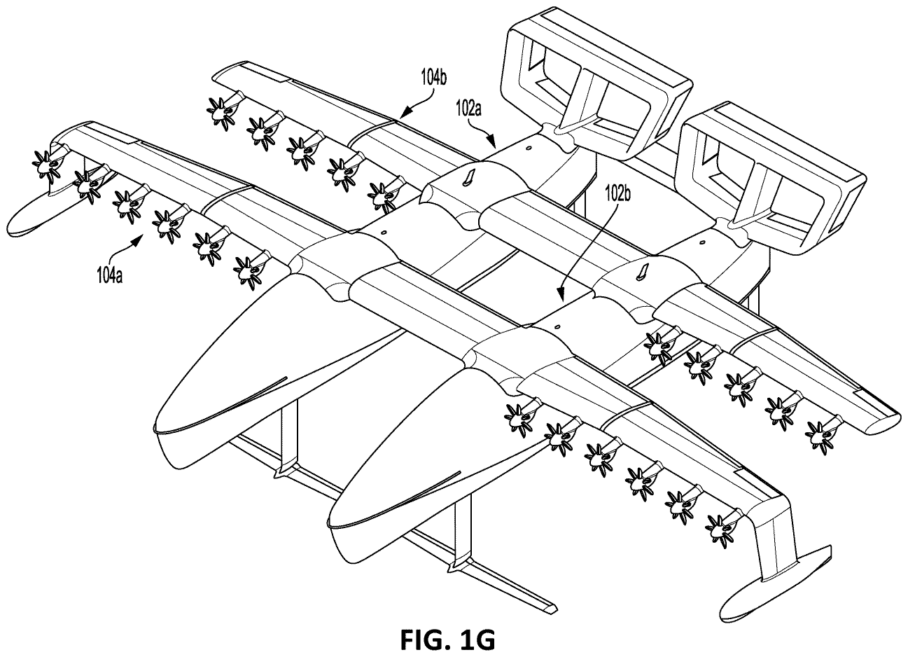

FIGS. 1A-1D illustrate different views of an example of a craft 100. As shown, some examples of the craft 100 include a hull 102, a main wing 104, a tail 106, a main hydrofoil assembly 108, and a rear hydrofoil assembly 110.

### A. Hull

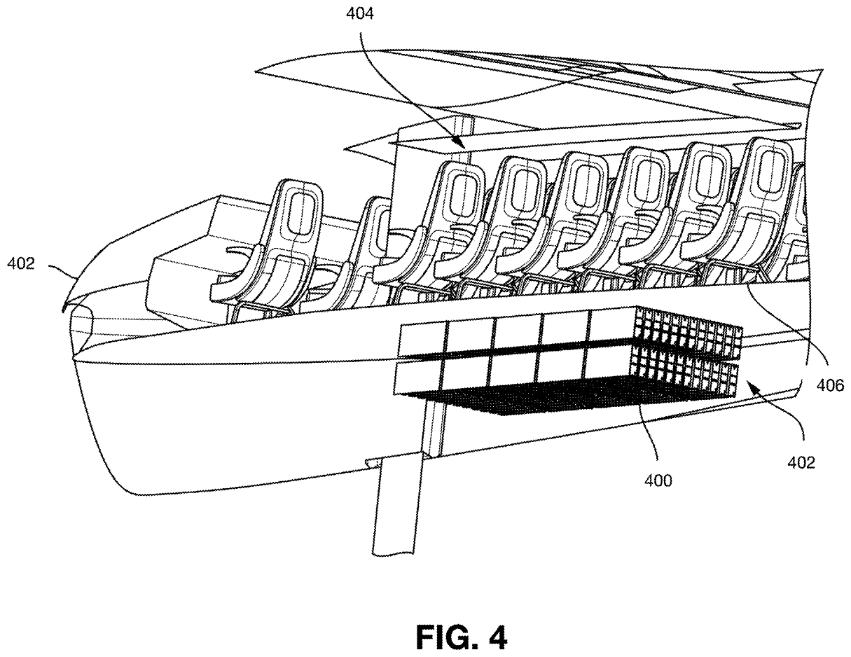

Some examples of the craft 100 operate in a first waterborne mode for an extended period of time, during which the hull 102 is at least partially submerged in water. As such, some examples of the hull 102 are configured to be watertight, particularly for surfaces of the hull that contact the water during this first waterborne operational mode. Further, some examples of the hull 102, as well as the entirety of the craft 100, are configured to be passively stable on all axes when floating in water. To help achieve this, some examples of the hull 102 include a keel (or centerline) 112, which provides improved stability and other benefits described below. Some examples of the craft 100 include various mechanisms for adjusting the center of mass of the craft 100 so that the center of mass aligns with the center of buoyancy of the craft 100. For instance, in some examples, a battery system (described in further detail below in connection with FIG. 4) of the craft 100 is electrically coupled to one or more moveable mounts. Some examples of the mounts are moved by one or more servo motors or the like. In some examples, a control system of the craft 100 is configured to detect a change in its center of buoyancy, for instance, by detecting a rotational change via an onboard gyroscope, and responsively operate the servo motors to move the battery system until the gyroscope indicates that the craft 100 has stabilized. Some examples of the craft 100 include a ballast system for pumping water or air to various tanks distributed throughout the hull 102 of the craft 100. The ballast system facilitates adjusting the center of mass of the craft 100 so that the center of mass aligns with the center of buoyancy of the craft 100. Other example systems may be used to control the center of mass of the craft 100 as well.

Additionally, or alternatively, some examples of the hull 102 are configured to reduce drag forces when both waterborne and wing-borne. For instance, some examples of the hull 102 have a high length-to-beam ratio (e.g., greater than or equal to 8), which facilitates reducing hydrodynamic drag forces when the craft 100 is under forward waterborne motion. Some examples of the keel 112 are curved or rockered to improve maneuverability when waterborne. Further, some examples of the hull 102 are configured to pierce the surface of waves (e.g., to increase passenger and crew comfort) by including a narrow, low-buoyancy bow portion of the hull 102.

Although in the example of FIGS. 1A-D, the craft 100 is illustrated as including a single hull 102, in other examples the craft 100 may include more than one hull. For instance, in the example of FIG. 1E, the craft 100 includes a first hull 102a and a second hull 102b.

### B. Wing and Distributed Propulsion System

As shown in FIGS. 1A-1D, some examples of the main wing 104 include an outrigger 114 at each end of the main wing 104. The outriggers 114 (which are sometimes referred to as “wing-tip pontoons”) are configured to provide a buoyant force to the main wing 104 when submerged or when otherwise in contact with the water, which improves the stability of the craft 100 during waterborne operation. Some examples of the outriggers 114 may also include integrated pumps (e.g., propeller pumps) that facilitate providing thrust in some scenarios, as described in more detail below.

As shown in FIG. 1D, some examples of the main wing 104 have a gull-wing shape such that the outriggers 114 at the ends of the main wing 104 are at the lowest point of the main wing 104 and are positioned approximately level with (or slightly above) a waterline of the hull 102 when the hull 102 is waterborne.

Some examples of the main wing 104 have a high aspect ratio, which is defined as the ratio of the span of the main wing 104 to the mean chord of the main wing 104. In some examples, the aspect ratio of the main wing 104 is greater than or equal to five, or greater than or equal to six, but other example aspect ratios are possible as well. Such wings tend to have reduced pitch stability and maneuverability due to lower roll angular acceleration. These issues are ameliorated by various mechanisms described below. On the other hand, such wings tend to have increased roll stability and increased efficiency resulting from higher lift-to-drag ratios. Further, high aspect ratio wings provide a longer leading edge for the mounting of a distributed propulsion system along the wing.

As shown in the figures, some examples of the main wing 104 include a number of electric motor propeller assemblies 116 distributed across a leading edge of the main wing 104. This arrangement corresponds to a blown-wing propulsion system. Arranging the propeller assemblies 116 in this manner increases the speed of air moving over the main wing 104, which increases the lift generated by the main wing 104. This increase in lift allows the craft 100 to take off and become wing-borne at slower vehicle speeds. This facilitates, for example, taking off on water which can be difficult at higher speeds due to the various forces that would otherwise act on the craft 100.

The electric motor propeller assemblies 116 tend to be much lighter, less complex, and smaller than the liquid-fueled engines used on conventional craft. Some examples of the electric motor propeller assemblies 116 are controlled by an electronic speed controller and powered by an onboard battery system (e.g., a lithium-ion system, magnesium-ion system, lithium-sulfur system, etc.). Some examples of the electric motor propeller assemblies 116 are controlled by a fuel cell or a centralized liquid-fueled electricity generator. In some examples, the onboard electrical supply system includes multiple systems for supplying power during different operational modes, such as a first battery system configured to deliver large amounts of power during takeoff and a second system with a higher energy density but lower peak power capability for delivering sustained lower power during cruise operation (e.g., during hydrofoil waterborne operation or during wing-borne operation, each of which are described in further detail below).

In some examples, the positioning of the electric motor propeller assemblies 116 along the leading edge of the main wing 104 is determined based on a variety of factors including, but not limited to, (i) the total thrust for all modes of operation of the craft 100, (ii) the thrust generated by each individual propeller of the propeller assemblies 116, (iii) the radius of each propeller in the respective propeller assemblies 116, (iv) the tip clearance between each propeller and the surface of the water, and (v) the additional freestream speed over the main wing 104 required for operation.

As shown in the figures, in some examples, the number of propeller assemblies 116 is symmetrical across both sides of the hull 102. In some examples, the propeller assemblies 116 are identical. In some examples, the propeller assemblies 116 have different propeller radii or blade configurations along the span so long as the configuration is symmetrical across the hull 102. The different radii facilitate adequate propeller tip clearance from the water or vehicle structure. In some examples, the different propellers are optimized for different operational conditions, such as wing-borne cruise. The propeller placement and configuration may vary to increase the airflow over the main wing 104 or tail system 106 to improve controllability or stability. While twelve total propeller assemblies 116 are illustrated, the actual number of propeller assemblies 116 can vary based on the requirements of the craft 100.

In some examples, the propeller assemblies 116 have different pitch settings or variable pitch capabilities based on their position on the main wing 104. For instance, in some examples, a subset of the propeller assemblies 116 have fixed-pitch propellers sized for cruise speeds, while the remainder of the propeller assemblies 116 have fixed-pitch propellers configured for takeoff or can allow for varying the propeller's pitch.

In some examples, different propeller assemblies 116 are turned off or have reduced rotational speeds during different modes of operation. For instance, during waterborne operation, one or more of the propeller assemblies 116 may be turned off or have reduced rotational speeds in a manner that generates asymmetrical thrust. This may create a yawing moment on the craft 100, allowing the craft 100 to turn without large bank angles and increasing the turning maneuverability of the craft 100. For instance, in order to yaw right, the craft 100 may increase the rotational speeds of the propellers of one or more of propeller assemblies 116g-1 while decreasing the rotational speeds of the propellers of one or more of propeller assemblies 116a-f. Similarly, to yaw left, the craft 100 may increase the rotational speeds of the propellers of one or more of propeller assemblies 116a-f while decreasing the rotational speeds of the propellers of one or more of propeller assemblies 116g-1.

Similarly varying rotational speeds or propeller pitches may be used to yaw or roll the aircraft in flight or while foiling due to varied forces and lift distributions imposed over the wing and its control surfaces or in general used to tailor the lift distribution across the wing for optimized efficiency.

In some examples, the propeller assemblies may tilt to vector thrust either to provide directly more vertical lift or to change how the wing is blown depending on the mode of operation so as to tailor the blown lift distribution.

Some examples of the main wing 104 include one or more aerodynamic control surfaces, such as flaps 118 and ailerons 120. Some examples of these controls comprise movable hinged surfaces on the trailing or leading edges of the main wing 104 for changing the aerodynamic shape of the main wing 104. Some examples of the flaps 118 are configured to extend downward below the main wing 104 to reduce stall speed and create additional lift at low airspeeds, while some examples of the ailerons 120 are configured to extend upward above the main wing 104 to decrease lift on one side of the main wing 104 and induce a roll moment in the craft 100. In some examples, the ailerons 120 are additionally configured to extend downward below the main wing 104 in a flaperon configuration to help the flaps 118 generate additional lift on the main wing 104, which, in some examples, is used to either create a rolling moment or additional balanced lift depending on coordinated movement of both ailerons. Some examples of the flaps 118 and ailerons 120 include one or more actuators for raising and lowering the flaps 118 and ailerons 120. Within examples, the flaps 118 include one or more of plain flaps, split flaps, slotted flaps, Fowler flaps, slotted Fowler flaps, Gouge flaps, Junkers flaps, or Zap flaps. Further, in some examples, the flaps 118 (and the ailerons 120 when configured as flaperons) are positioned to be in the wake of one or more of the propeller assemblies 116. In some examples, the ailerons 120 are positioned so that they are in the wake of one or more of the propeller assemblies 116 to increase the effectiveness of the ailerons at low forward velocities. Some of the propeller assemblies 116 are positioned so that no ailerons 120 are in their wake to increase thrust on the outboard wing during a turn without inducing adverse yaw. For example, in a left turn, a normal airplane would have adverse yaw to the right as the right aileron is deflected down, increasing drag. In the present disclosure, however, the right propeller assembly outboard of the right aileron may have its thrust increased relative to the respective left propeller assembly, initiating a turn without adverse yaw.

Although in the example of FIGS. 1A-D, the craft 100 is illustrated as including a single main wing 104, in other examples the craft 100 may include more than one wing. For instance, in the example of FIG. 1F, the craft 100 includes a first wing 104a and a second wing 104b. In another example, and as shown in FIG. 1G, the craft 100 includes a first hull 102a, a second hull 102b, a first wing 104a, and a second wing 104b. Other examples are possible as well.

### C. Tail System

As illustrated in FIGS. 1A-1D, some examples of the tail 106 include a vertical stabilizer 122, a horizontal stabilizer 124, and one or more control surfaces, such as elevators 126. Similar to the flaps 118 and ailerons 120, some examples of the elevators 126 comprise movable hinged surfaces on the trailing or leading edges of the horizontal stabilizer 124 for changing the aerodynamic shape of the horizontal stabilizer 124 to control a pitch of the craft 100. Some examples of the horizontal stabilizer 124 are combined with the elevator 126, creating a fully articulating horizontal stabilizer (e.g., a stabilator). Raising the elevator 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. Some examples of the elevators 126 include actuators, which are operated by a control system of the craft 100 to raise and lower the elevators 126.

As illustrated in FIGS. 1A-1D, some examples of tail 106 include a rudder 128. Some examples of the rudder 128 comprise a movable hinged surface on the trailing edge of the vertical stabilizer 122 for changing the aerodynamic shape of the vertical stabilizer 122 to control the yaw of the craft 100 when operating in an airborne mode. In some examples, the rudder 128 additionally changes a hydrodynamic shape of the hull 102 to control the yaw of the craft 100 when operating in a waterborne mode. To facilitate such hydrodynamic control, in some examples, the rudder 128 is positioned low enough on the tail 106 that the rudder 128 is partially or entirely submerged when the hull 102 is floating in water. For instance, the rudder 128 is positioned partially or entirely below the waterline of the hull 102. Some examples of the rudder 128 include one or more actuators, which are operated by a control system of the craft 100 to rotate the hinged surface of the rudder 128 to the left or right of the vertical stabilizer 122. Actuating the rudder 128 to the left (relative to the direction of travel) causes the craft 100 to yaw left. Actuating the rudder 128 to the right (relative to the direction of travel) causes the craft 100 to yaw right. As such, the rudder 128 may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

Some examples of the tail 106 include one or more vertical stabilizers 122a, 122b, 122n, one or more horizontal stabilizers 124a, 124b, one or more control surfaces, such as elevators 126a, 126b and one or more tail flaps 127 for enhanced pitch control configured to exert enhanced net downward force on the tail system. It should be understood that although the figures show only two horizontal stabilizers, it is contemplated that more than two of each can be used within the scope of the present teachings. In some applications, it has been found that the transition from waterborne operation to airborne or wing-borne operation can require a larger pitching moment to overcome the larger drag forces existing between the hull 102 and/or the hydrofoil assemblies 108, 110 and the water. This phenomenon can further occur in wheeled aircraft configured for short takeoff and landing (STOL) operations. In this way, at low airspeeds, aerodynamic forces in conventional designs fail to produce sufficient downward force to permit sufficient pitching moment. To provide sufficient pitching moment to pitch the craft 100 upward, a conventional solution would be to increase the span of the tail so that the elevator generates more force; however, a resultant consequence of increasing the span of the tail is that the entire tail must be stronger and heavier, which can result in undesired reduction of payload and efficiency. However, the present configuration provides improved performance by providing a tail 106 having a first horizontal stabilizer 124a and a second horizontal stabilizer 124b. It should be understood that one or more additional horizontal stabilizers can be used.

In some examples, a first horizontal stabilizer 124a is a lower horizontal stabilizer relative to a second horizontal stabilizer 124b. However, it should be appreciated that the horizontal stabilizers in some examples can be interchanged for performance purposes (e.g., the disclosed structure of the first horizontal stabilizer 124a can be incorporated in the upper horizontal stabilizer and the disclosed structure of the second horizontal stabilizer 124b can be incorporated in the lower horizontal stabilizer). In some non-limiting examples, the structure, shape, and/or performance of each horizontal stabilizer can be tailored as desired such that the lower horizontal stabilizer (in this example, the first horizontal stabilizer 124a) is more likely to experience aerodynamic effect from being in the wake of the blown-wing propulsion system disclosed herein or associated wake produced by alternative propulsion systems. In this way, greater aerodynamic control and/or downwards lift can be generated during desired phases of operation.

Some examples of the horizontal stabilizers 124a, 124b include one or more aerodynamic control surfaces, such as tail flaps 127 and elevators 126, which may comprise movable hinged surfaces on the trailing or leading edges of the horizontal stabilizer 124a, 124b for changing the aerodynamic shape of the respective horizontal stabilizer 124a, 124b. It should be recognized that at least one of the horizontal stabilizers 124a, 124b can be sized, shaped, and/or spaced relative to a second of the horizontal stabilizers 124a, 124b to enhance or minimize the aerodynamic effect on the adjacent stabilizers. In this way, the aerodynamic flow, pressures, and/or forces can be used to improve the efficiency or effectiveness of the adjacent stabilizer. In some examples, at least one of the horizontal stabilizers 124a, 124b can be actuated in an opposing direction. In some embodiments, at least one of the horizontal stabilizers 124a, 124b can define a ratio of a surface area of the first horizontal stabilizer to a surface area of the second horizontal stabilizer in the range of 0.9 to 1.6. In some non-limiting example configurations, the surface area of the first horizontal stabilizer is 5.7 m2, the surface area of the second horizontal stabilizer is 3.9 m2, and both have a chord of about 1 m and a vertical separation of 1.8 m. In some embodiments, a vertical separation distance between the first horizontal stabilizer and the second horizontal stabilizer is in the range of 0.25 to 0.75 of the lower horizontal stabilizer span. In some examples, a vertical separation distance can be dependent on the required rudder authority and thus elevator size (driven by, e.g., yaw stability, or the need to counteract asymmetric thrust following powerplant failure). In some examples, a sweep offset moves the center of pressure further aft from the center of gravity, thus allowing the airfoil of the horizontal stabilizer to have less surface area overall, thus being smaller and lighter. In some examples, a dihedral in the bottom surface of the horizontal stabilizer adds stability. In some examples, the box tail design itself increases the efficiency due to the elimination of wingtip vortices of a typical tail. In some embodiments, a lower horizontal stabilizer may have approximately a 15% thickness-to-chord ratio to support the weight of the upper components, whereas the vertical and upper surfaces may be thinner, such as, for example, 10% thickness-to-chord ratio due to reduced structural load requirement, which enables the upper horizontal stabilizer to be more efficient (lower drag). It should be appreciated that the left and right elevator surfaces 126 can be controlled independently and/or differentially to create a rolling moment, thereby enabling the wing ailerons 120 to be made smaller. The smaller wing ailerons 120 further enable larger flaps 118. It should be appreciated that in some embodiments, using the vertical control surfaces 128a, 128b, 128n can change the pressure distribution across the elevator 126, for example, commanding a left 5 degree deflection in the left vertical control surface may move the mean pressure distribution left/right by a percentage of the elevator width.

Some examples of the tail flaps 127 are configured to selectively extend upward above the horizontal stabilizer 124 for changing a surface area, camber, aspect ratio, and/or shape of the horizontal stabilizer 124. The tail flaps 127 may include, for example, one or more of plain flaps, split flaps, slotted flaps, Fowler flaps, slotted or double-slotted Fowler flaps, Gouge flaps, Junkers flaps, or Zap flaps. That is, in some examples, tail flaps 127 serve to change an angle of attack of the horizontal stabilizer 124, change a chord line of the horizontal stabilizer 124, change a surface area of the horizontal stabilizer 124, and/or otherwise increase the net effective downwardly directed lift of the horizontal stabilizer 124. Such configurations effectively reduce the speed at which the horizontal stabilizer 124 becomes aerodynamically effective by creating additional net downward force at low airspeeds to aid in exerting a nose-up pitching moment of the craft 100. The elevators 126 may be configured for changing the aerodynamic shape of the horizontal stabilizer 124 to further control or vary a pitch of the craft 100.

In some examples operations, the tail flaps 127 are deployed for takeoff (e.g., transition from hydrofoil-borne mode to airborne mode) and landing (e.g., transition from airborne mode to hull-borne mode) to generate additional downforce on the tail system when additional pitch-up moment is required. Tail flaps 127 can be stowed for other phases of operation, such as hull-borne mode, to reduce downforce on the tail system and reduce drag.

In some examples, the elevators 126 are additionally configured to extend upward above the horizontal stabilizer 124 in a flaperon-like configuration (yet with elevators, rather than ailerons) to help the tail flaps 127 generate additional downward force on the horizontal stabilizer 124, which may be used to either create a pitching moment or additional balanced downward force. The tail flaps 127 and elevators 126 may each include one or more actuators 125 for raising and lowering the tail flaps 127 and elevators 126, singly or in combination. The actuators 125 can comprise any system configured to selectively actuate the associated system, such as but not limited to a flap track system (integrated into vertical stabilizers 122a, 122b, 122n, which can reduce complex hinge systems or external arms, thereby reducing wetted area and excrescences drag), an electric servo motor mounting within the vertical stabilizers 122a, 122b, 122n and/or horizontal stabilizers 124a, 124b, and/or a central vertical strut system generally mounted in the hull 102 (to provide the potential for reduced cross-sectional area and associated drag).

Further, in some examples, the elevators 126 and/or the tail flaps 127 are positioned so that they are in the wake 129 of one or more of the propeller assemblies 116 of main wing 104. The elevators 126 and/or the tail flaps 127 may be positioned so that they are in the wake 129 of one or more of the propeller assemblies 116 to increase the effectiveness of the elevators at low forward velocities. In some examples, the propeller assemblies 116 are positioned so that no elevators 126 and/or tail flaps 127 are in the wake 129 to ensure consistent and/or predictable aerodynamic forces, independent of power application, are exerted during critical operational phases. In some examples, the propeller assemblies 116 are positioned so that the elevators 126 are in their wake 129 and the tail flaps 127 are not in the wake 129 (e.g., above the wake 129) and are exposed to clean air 131. It should be understood that positioning of the tail flaps 127 in the second horizontal stabilizer 124b, or at a distance above the center of gravity of the craft 100, will have the added unexpected benefit of creating additional nose-up pitching moment as a result of induced drag acting about the center of gravity causing the craft 100 to pitch upward.

Similar to the flaps 118 and the ailerons 120 of the main wing 104, some examples of the elevators 126 comprise movable hinged surfaces on the trailing or leading edges of the horizontal stabilizer 124 for changing the aerodynamic shape of the horizontal stabilizer 124 to control a pitch of the craft 100. The horizontal stabilizer 124 may be combined with the elevator 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. The elevators 126 may include actuators, which may be operated by a control system of the craft 100 in order to raise and lower the elevators 126.

In some examples, the tail 106 includes one or more rudders 128a, 128b, 128n. The rudders 128a, 128b, 128n may each comprise a movable hinged surface on the trailing edge of the corresponding vertical stabilizers 122a, 122b, 122n for changing the aerodynamic shape of the vertical stabilizer 122 to control the yaw of the craft 100 when operating in an airborne mode. It should be understood that rudders 128a, 128b, 128n can operate independently or in combination as desired. Moreover, in some examples, rudders 128a, 128b, 128n can be used as redundant systems, particularly useful in the event of one or more failures.

In some examples, the rudders 128a, 128b, 128n additionally change a hydrodynamic shape of the hull 102 to control the yaw of the craft 100 when operating in a waterborne mode. In order to facilitate such hydrodynamic control, the rudders 128a, 128b, 128n may be positioned low enough on the tail 106 that one or more of the rudders 128a, 128b, 128n is partially or entirely submerged when the hull 102 is floating in water. Namely, the rudders 128a, 128b, 128n may be positioned partially or entirely below a waterline of the hull 102. The rudders 128a, 128b, 128n may include one or more actuators, which may be operated by a control system of the craft 100 in order to rotate the hinged surface of the rudders 128a, 128b, 128n to the left or right of the vertical stabilizer 122. Actuating the rudders 128a, 128b, 128n to the left (relative to the direction of travel) causes the craft 100 to yaw left. Actuating the rudders 128a, 128b, 128n to the right (relative to the direction of travel) causes the craft 100 to yaw right. As such, the rudders 128a, 128b, 128n may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

It should be understood that the fundamental shape of tail 106, having one or more vertical stabilizers 122a, 122b, 122n and one or more horizontal stabilizers 124a, 124b, can result in a box-like assembly, wherein the vertical stabilizers are generally coupled to the horizontal stabilizers to form a reinforced box-like construction. This box-like construction provides enhanced structural integrity that enables tail 106 of some examples to be lighter and/or smaller than otherwise constructed.

Some examples of the craft 100 include a distributed propulsion system on the tail 106, which may be similar to the distributed propulsion system of propeller assemblies 116 on the main wing 104. Such a distributed propulsion system may provide similar benefits of increasing the freestream velocity over the control surfaces (e.g., the elevators 126 and/or the rudder 128) to allow for increased pitch and yaw control of the craft 100 at lower travel speeds. When determining the number and size of propeller assemblies to include on the tail 106, one may apply the same factors described above when determining the number and size of propeller assemblies to include on the main wing 104.

### D. Hydrofoil Systems

As noted above, some examples of the craft 100 include a main hydrofoil assembly 108 and a rear hydrofoil assembly 110. In some examples, the main hydrofoil assembly 108 is positioned proximate to the middle or bow of the craft 100, and the rear hydrofoil assembly 110 is positioned proximate to the stern. For instance, some examples of the main hydrofoil assembly 108 is positioned between the bow and a midpoint (between the bow and stern) of the craft 100, and some examples of the rear hydrofoil assembly 110 is positioned below the tail 106 of the craft 100.

The main hydrofoil assembly 108 and the rear hydrofoil assembly 110 are configured to facilitate the breaking of contact between the hull of the craft and the water surface during takeoff, which can otherwise be challenging in some conventional craft designs. Some examples of the main hydrofoil assembly 108 and the rear hydrofoil assembly 110 are configured to be retractable, large enough to lift the entire craft out of the water and not impact the water surface, and to enable sustained operation in the hydrofoil-borne mode (where the entire weight of the craft is supported by the one or more hydrofoil assemblies).

Some examples of the main hydrofoil assembly 108 include a main hydrofoil 130, one or more main hydrofoil struts 132 that couple the main hydrofoil 130 to the hull 102, and one or more main hydrofoil control surfaces 134. Similarly, some examples of the rear hydrofoil assembly 110 include a rear hydrofoil 136, one or more rear hydrofoil struts 138 that couple the rear hydrofoil 136 to the hull 102, and one or more rear hydrofoil control surfaces 140.

Some examples of the main hydrofoil 130 and the rear hydrofoil 136 take the form of one or more hydrodynamic lifting surfaces (also referred to as “foils”) configured to be operated partially or entirely submerged underwater while the hull 102 of the craft 100 remains above and clear of the water's surface. In operation, as the craft 100 moves through water with the main hydrofoil 130 and the rear hydrofoil 136 submerged, the hydrofoils generate a lifting force that causes the hull 102 to rise above the surface of the water. In general, the lifting force generated by the hydrofoils must be at least equal to the weight of the craft 100 to cause the hull 102 to rise above the surface of the water. The lifting force of the hydrofoils depends on the speed and angle of attack at which the hydrofoils move through the water, as well as their various physical dimensions, including the aspect ratio, the surface area, the span, and the chord of the foils.

The height at which the hull 102 is elevated above the surface of the water during hydrofoil-borne operation is limited by the length of the one or more main hydrofoil struts 132 that couple the main hydrofoil 130 to the hull 102 and the length of the one or more rear hydrofoil struts 138 that couple the rear hydrofoil 136 to the hull 102. In some examples, the main hydrofoil strut 132 and the rear hydrofoil strut 138 are long enough to lift the hull 102 at least five feet above the surface of the water during hydrofoil-borne operation, which facilitates operation in substantially choppy waters. Struts of other lengths may be used as well. For instance, in some examples, longer struts that allow for better wave-isolation of the hull 102 (but at the expense of the stability of the craft 100 and increasing complexity of the retraction system) are utilized.

In practice, hydrofoils have a limited top speed before cavitation occurs, which results in vapor bubbles forming and imploding on the surface of the hydrofoil. Cavitation not only may cause damage to a hydrofoil but also significantly reduces the amount of lift generated by the hydrofoil and increases drag. Therefore, it is desirable to reduce the onset of cavitation by designing the main hydrofoil 130 and the rear hydrofoil 136 in a way that allows the hydrofoils to operate at higher speeds (e.g., ~20-45 mph) and across the entire required hydrofoil-borne speed envelope before cavitation occurs. For instance, in some examples, the onset of cavitation is controlled based on the geometric design of the main hydrofoil 130 and the rear hydrofoil 136. Additionally, in some examples, the structural design of the main hydrofoil 130 and the rear hydrofoil 136 is configured to allow the surfaces of the hydrofoils to flex and twist at higher speeds, which may reduce loading on the hydrofoils and delay the onset of cavitation.

Further, in some examples, the distributed blown-wing propulsion system described above further facilitates the delay of onset of cavitation on the main hydrofoil 130 and the rear hydrofoil 136. Cavitation is caused by both (i) the amount of lift generated by a hydrofoil and (ii) the profile of the hydrofoil (which is affected by both the hydrofoil's angle of attack and its vertical thickness) as it moves through water. Reducing the amount of lift generated by the hydrofoil delays the onset of cavitation. Because the blown-wing propulsion system creates additional lift on the main wing 104, the amount of lift exerted on the main hydrofoil 130 and the rear hydrofoil 136 to lift the hull 102 out of the water is reduced. Further, because the main hydrofoil 130 and the rear hydrofoil 136 do not need to generate as much lift to raise the hull 102 out of the water, their angles of attack may be reduced as well, which further delays the onset of cavitation. In some examples, combining the blown-wing propulsion system with the hydrofoil designs described herein facilitates operating the craft 100 in a hydrofoil-borne mode at speeds above 35 knots before cavitation occurs.

As noted above, some examples of the main hydrofoil assembly 108 and the rear hydrofoil assembly 110 include one or more main and rear hydrofoil control surfaces 134, 140, respectively. Some examples of the main hydrofoil control surfaces 134 include one or more hinged surfaces on a trailing or leading edge of the main hydrofoil 130 as well as one or more actuators which are operated by the control system of the craft 100 to rotate the hinged surfaces so that they extend above or below the main hydrofoil 130. Some examples of the main hydrofoil control surfaces 134 on the main hydrofoil 130 are operated in a similar manner as the flaps 118 and ailerons 120 on the main wing 104 of the craft 100. In some examples, lowering the control surfaces 134 to extend below the main hydrofoil 130 changes the hydrodynamic shape of the main hydrofoil 130 in a manner that generates additional lift on the main hydrofoil 130, similar to the aerodynamic effect of lowering the flaps 118. In some examples, asymmetrically raising one or more of the control surfaces 134 (e.g., raising a control surface 134 on only one side of the main hydrofoil 130) changes the hydrodynamic shape of the main hydrofoil 130 in a manner that generates a roll force on the main hydrofoil 130, similar to the aerodynamic effect of raising one of the ailerons 120.

Likewise, some examples of the rear hydrofoil control surfaces 140 include one or more hinged surfaces on a trailing or leading edge of the rear hydrofoil 136 as well as one or more actuators, which are operated by the control system of the craft 100 to rotate the hinged surfaces so that they extend above or below the rear hydrofoil 136. In some examples, the rear hydrofoil control surfaces 140 on the rear hydrofoil 136 are operated in a similar manner as the elevators 126 on the tail 106 of the craft 100. In some examples, lowering the control surfaces 140 to extend below the rear hydrofoil 136 changes the hydrodynamic shape of the rear hydrofoil 136 in a manner that causes the craft 100 to pitch downwards, similar to the aerodynamic effect of lowering the elevators 126. In some examples, raising the control surfaces 140 to extend above the rear hydrofoil 136 changes a hydrodynamic shape of the rear hydrofoil 136 in a manner that causes the craft 100 to pitch upwards, similar to the aerodynamic effect of raising the elevators 126.

In some examples, one or both of the main hydrofoil control surfaces 134 or the rear hydrofoil control surfaces 140 include rudder-like control surfaces similar to the rudder 128 on the tail 106 of the craft 100. For instance, some examples of the main hydrofoil control surfaces 134 include one or more hinged surfaces on a trailing edge of the main hydrofoil strut 132 as well as one or more actuators, which are operated by the control system of the craft 100 to rotate the hinged surfaces so that they extend to the left or right of the main hydrofoil strut 132. Similarly, some examples of the rear hydrofoil control surfaces 140 include one or more hinged surfaces on a trailing edge of the rear hydrofoil strut 138 as well as one or more actuators, which are operated by the control system of the craft 100 in order to rotate the hinged surfaces so that they extend to the left or right of the rear hydrofoil strut 138. In some examples, actuating the main hydrofoil control surfaces 134 or the rear hydrofoil control surfaces 140 in this manner changes the hydrodynamic shape of the main hydrofoil strut 132 or the rear hydrofoil strut 138, respectively, which facilitates controlling the yaw of the craft 100 when operating in a waterborne or hydrofoil-borne mode, similar to the effect of actuating the rudder 128 of the craft 100, as described above.

In some examples, instead of (or in addition to) actuating hinged control surfaces on the main hydrofoil 130 and/or the rear hydrofoil 136, a control system of the craft 100 actuates the entire main hydrofoil 130 and/or the entire rear hydrofoil 136 themselves. In some examples, the craft 100 includes one or more actuators for rotating the main hydrofoil 130 and/or the rear hydrofoil 136 around the yaw axis. In some examples, the craft 100 includes one or more actuators for controlling the angle of attack of the main hydrofoil 130 and/or the rear hydrofoil 136 (i.e., rotating the main hydrofoil 130 and/or the rear hydrofoil 136 around the pitch axis). Some examples of the craft 100 include one or more actuators for rotating the main hydrofoil 130 and/or the rear hydrofoil 136 around the roll axis. Some examples of the craft 100 include one or more actuators for changing a camber or shape of the main hydrofoil 130 and/or the rear hydrofoil 136. Some examples of the craft 100 include one or more actuators for flapping the main hydrofoil 130 and/or the rear hydrofoil 136 to help propel the craft 100 forward or backward. Other examples are possible as well.

Further, some examples of the craft 100 dynamically control an extent to which the main hydrofoil 130 and/or the rear hydrofoil 136 are deployed based on an operational mode (e.g., hull-borne, hydrofoil-borne, or wing-borne modes) of the craft 100. For instance, in some examples, during hull-borne mode, the rear hydrofoil assembly 110 is partially deployed or retracted to increase turning authority. The amount of partial deployment or retraction may be a function of the desired overall vehicle draft when operating in a shallow water environment. In some examples, during hydrofoil-borne mode, the main hydrofoil assembly 108 is partially retracted to reduce the distance between the hull of the vehicle and the water's surface. This increases the amount of lift generated by the main wing 104 by operating the wing closer to the surface of the water, increasing the effects of the aerodynamic ground effect.

As noted above, some examples of the main hydrofoil assembly 108 and rear hydrofoil assembly 110 interface with a deployment system that facilitates retracting the respective hydrofoil assemblies 108, 110 into or toward the hull 102 for hull-borne or wing-borne operation and for extending the respective hydrofoil assemblies 108, 110 below the hull 102 for hydrofoil-borne operation. As described further below, in some embodiments, the deployment system is used in connection with extending, retracting, and/or otherwise controlling the positioning of the hydrofoil assemblies 108, 110 during takeoff when the craft is transitioning from hydrofoil-borne operation to wing-borne operation.

### E. Hydrofoil Deployment Systems

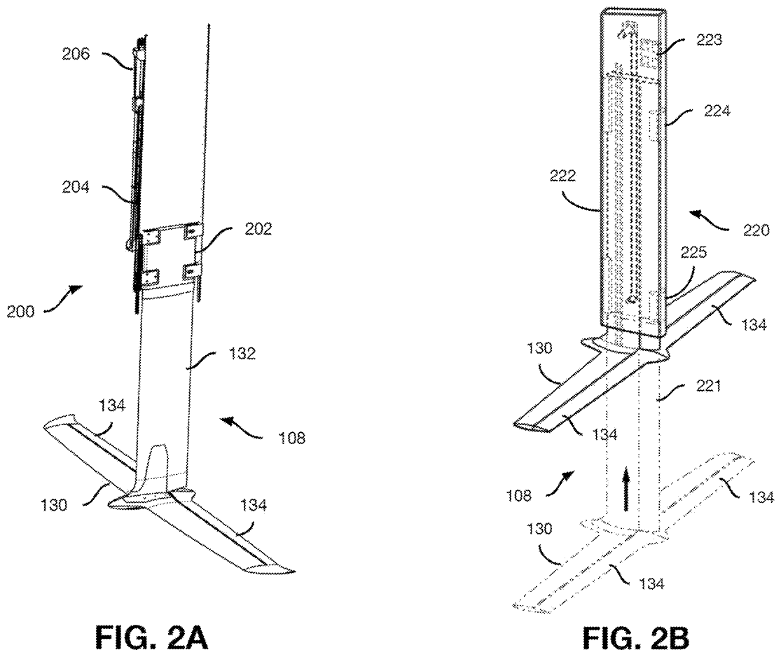

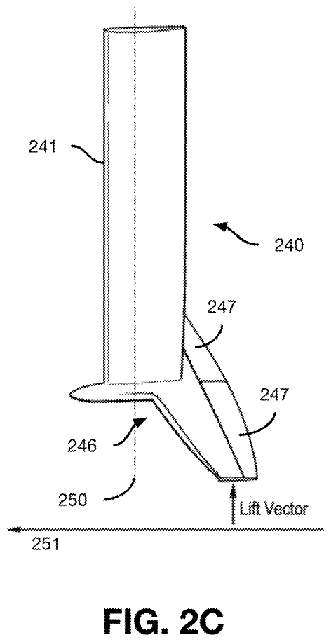

FIGS. 2A-B illustrate two examples of main hydrofoil deployment systems 200, 220 that facilitate retracting and extending of the main hydrofoil assembly 108. As shown in FIG. 2A, one example of the main hydrofoil deployment system 200 takes the form of a linear actuator that includes one or more brackets 202 that couple the main hydrofoil assembly 108 (by way of the main hydrofoil strut 132) to one or more vertical tracks 204. Some examples of the brackets 202 are configured to move vertically along the tracks 204, such that when the brackets 202 move vertically along the tracks 204, the main hydrofoil assembly 108 likewise moves vertically. Some examples of the brackets 202 are coupled to a leadscrew 206 that, when rotated, causes vertical movement of the brackets 202. Some examples of the leadscrew 206 are rotatable by any of various sources of torque, such as an electric motor coupled to the leadscrew 206 by a gear assembly.

Some examples of the main hydrofoil deployment system 200 further include one or more sensors (not shown) configured to detect a vertical position of the main hydrofoil assembly 108 (including the main foil 130 and main control surfaces 134). For example, a first sensor senses when the main hydrofoil assembly 108 has reached a fully retracted position and a second sensor senses when the main hydrofoil assembly 108 has reached a fully extended position. However, the main hydrofoil deployment system 200 may include additional sensors for detecting additional discrete positions or continuous positions of the main hydrofoil assembly 108. Some examples of the sensors are included as part of, or otherwise configured to communicate with, the control system of the craft 100 to provide the control system with data that indicates the position of the main hydrofoil assembly 108. Some examples of the control system use this data to determine whether to operate the electric motor to retract or extend the main hydrofoil assembly 108.

In some examples, such as examples where the linear actuator is not a self-locking linear actuator, the main hydrofoil deployment system 200 includes a locking or braking mechanism for holding the main hydrofoil strut 132 in a fixed position (e.g., in a fully retracted or fully extended position). An example of the locking mechanism corresponded to a dual-action mechanical brake that is coupled to the electric motor, the leadscrew 206, or the gear assembly.

FIG. 2B shows a perspective view of another example hydrofoil deployment system 220 having a strut 221 with interlock 223, and a casing 222 with catches 224, 225 for holding the main hydrofoil strut 221 in a fixed position. In other crafts, the catches 224, 225 can be located in a different structure, such as for example, a dual-channel configuration. Both configurations are discussed in PCT/US24/48937, entitled “Hydrofoil Retraction System” and filed on Sep. 27, 2024. The first catch 224 is located toward the top of the casing 222 and is in a position to lock the strut 221 in place when the hydrofoil deployment system 220 is in a fully-retracted position. The second catch 225 is located toward the bottom of the casing 222 and is in a position to lock the strut 221 in place when the hydrofoil deployment system 220 is in a fully-deployed position. While two catches 224, 225 are shown in this example, one or more additional catches can be used to lock the strut 221 in place when the hydrofoil deployment system 220 is in one or more positions between the fully-deployed and fully-retracted positions. In other embodiments, only a single catch is used. In still other embodiments, a relatively large number of catches may be used, such as 10 or more catches. Also, the catch can be the sole locking mechanism for the hydrofoil deployment system 220 or can be used in conjunction with other locking mechanisms. Further, the interlock 223 can be responsible for rigidly/securely holding the hydrofoil deployment system 220 in place (at various places) throughout the deployment of the hydrofoil deployment system 220 by selectively engaging with the catches 224, 225.

FIG. 2C shows another example hydrofoil assembly 240 with a strut 241 and a foil 246 with control surfaces 247. In this example, the position of the foil 246 is backward relative to the strut 241 so that the lift vector 249 is off-center with respect to the vertical axis 250 of the strut 241. As a result, the control surfaces 247 are behind the vertical axis 250. This arrangement works to more-strongly push the strut 241 against one side of the casing (not shown), placing the strut 241 on the “negative side” of any forward/backward movement inside the casing, regardless of the craft speed while foiling. As a result of the off-center foil position, the strut 241 is pushed adjacent to the rear of the casing (i.e., opposite the forward direction of movement 251).

While the above description provides various details of an example main hydrofoil deployment systems 200, 220, and example hydrofoil assemblies 108, 240, it should be understood that the main hydrofoil deployment system 200, 220 and hydrofoil assemblies 108, 240 illustrated in FIGS. 2A-C are for illustrative purposes and are not meant to be limiting. For instance, the main hydrofoil deployment systems 200, 220 may include any of various linear actuators now known or later developed that are capable of retracting and extending the main hydrofoil assembly 108. Similarly, the hydrofoil assemblies 108, 240 may be positioned forward, backward, or center to the strut 132, 241.

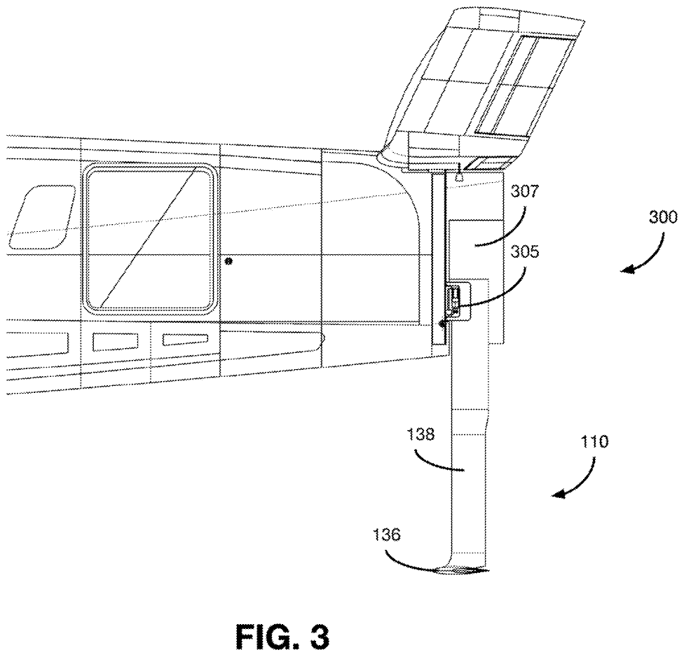

FIG. 3 illustrates an example of a rear hydrofoil deployment system 300 that facilitates retracting and extending the rear hydrofoil assembly 110. As shown, some examples of the rear hydrofoil deployment system 300 include an actuator 305 to the rear hydrofoil strut 138. When actuated, the actuator 305 causes the rear hydrofoil strut 138 to raise or lower by causing the rear hydrofoil strut 138 to slide vertically along a shaft 307. While not illustrated in FIG. 3, in some examples, the rudder 128 is mounted to the shaft 307 such that, when the actuator 305 raises the rear hydrofoil strut 138, the rear hydrofoil strut 138 retracts at least partially into the rudder 128. Additionally, some examples of the rear hydrofoil deployment system 300 include one or more servo motors configured to rotate the rear hydrofoil strut 138 around the shaft. In this respect, in some examples, the rear hydrofoil strut 138 is rotated around the shaft to act as a hydro-rudder when submerged in water or to act as an aero-rudder when out of the water. Further, because the rudder 128 is mounted to the same shaft 307 as the rear hydrofoil strut 138 and the rear hydrofoil strut 138 can be retracted into the rudder 128, the same servo motor can also be used to control the rotation of the rudder 128.

The actuator 305 of the rear hydrofoil deployment system 300 may take various forms and may, for instance, include any of various linear actuators now known or later developed that are capable of retracting and extending the rear hydrofoil assembly 110. Further, in some examples, the actuator 305 has a non-unitary actuation ratio such that a given movement of the actuator 305 causes a larger corresponding induced movement of the rear hydrofoil assembly 110. This can help allow for faster retractions of the rear hydrofoil assembly 110, which may be beneficial during takeoff.

Some examples of the main hydrofoil assembly 108 and/or the rear hydrofoil assembly 110 are configured such that, when fully retracted, the hydrofoil assembly is flush, conformal, or tangent to the hull 102. For instance, some examples of the hull 102 include one or more recesses configured to receive the main hydrofoil assembly 108 and/or the rear hydrofoil assembly 110. In this regard, some examples of the main hydrofoil assembly 108 and/or the rear hydrofoil assembly 110 have a shape such that when the main hydrofoil assembly 108 and/or the rear hydrofoil assembly 110 are fully retracted into the recesses of the hull 102, the outer contour of the hull 102 forms a substantially smooth transition at the intersection of the hull 102 and the main hydrofoil assembly 108 and/or the rear hydrofoil assembly 110.

Other examples of the main hydrofoil assembly 108 and/or the rear hydrofoil protrude slightly below the hull 102 when retracted. These examples of the main hydrofoil assembly 108 and/or the rear hydrofoil assembly 110 are configured to have a non-negligible effect on the aerodynamics of the craft 100. Some examples of the craft 100 are configured to leverage these effects to provide additional control of the craft 100. For instance, in some examples, when the main hydrofoil assembly 108 and/or the rear hydrofoil assembly 110 are retracted but still exposed, the exposed hydrofoil is manipulated in flight to impart forces and moments on the craft 100 similar to an aero-control surface.

Some examples of the hydrofoil assemblies 108, 110 disclosed herein are mounted on a pivot that is locked underwater but is unlocked to allow the hydrofoil to move around the pivot in the air. At that point, the control surfaces act like trim tabs and are able to effect movement of the entire unlocked, pivoting hydrofoil, which would otherwise require impractically large and heavy servo motors. This configuration facilitates unlocking and moving of the hydrofoil using a slow servo and/or a combination of control surface movement combined with forward movement through water, and then re-locked such that the hydrofoil is at a selected angle of incidence.

As noted above, some examples of the main hydrofoil assembly 108 are configured to be retractable. Some examples of the hull 102 include openings through which the strut 132 of the main hydrofoil assembly 108 are retracted and extended. Some examples of the hull 102 are configured to isolate water that enters through these openings (e.g., when the hull 102 contacts the water surface) and to allow for the water to drain from the hull 102 after the hull 102 is lifted out of the water. For instance, some examples of the hull 102 include pockets 142 on each side of the hull 102 aligned above the strut 132. Some examples of the pockets 142 are isolated from the remainder of the interior of the hull 102 so that water that accumulates in the pockets 142 does not reach any undesired areas (e.g., the cockpit, passenger seating area, areas that house the battery system 400, components of the control system of the craft 100, etc.). Further, some examples of the pockets 142 include venting holes or other openings located at or near the bottom of the pockets 142. The venting openings are configured to allow water that enters the pockets 142 to vent out of the pockets 142 when the hull 102 is lifted out of the water.

Some examples of the main hydrofoil assembly 108 and/or the rear hydrofoil assembly 110 include one or more propellers for additional propulsion when submerged underwater. For instance, in some examples, one or more propellers are mounted to the main hydrofoil 130 and/or the rear hydrofoil 136. In some examples, the propellers are configured to provide additional propulsion force to the craft 100 during hydrofoil-borne or hull-borne operation.

In some examples, propellers are mounted to the hull 102. The propellers are submerged during hull-borne operation. In some examples, the propellers are configured to provide additional propulsion force to the craft 100 during hull-borne operation.

Some examples of the main and/or rear hydrofoil assemblies 108, 110 include various failsafe mechanisms in case of malfunction. For instance, in some examples, when one or both of the main and rear hydrofoil deployment systems 200, 300 cannot be retracted due to a malfunction, the craft 100 is configured to jettison the malfunctioning assembly. In this regard, some examples of the main and/or rear hydrofoil assemblies 108, 110 are coupled to the hull 102 by a releasable latch. Some examples of the control system of the craft 100 are configured to identify a retraction malfunction (e.g., based on data received from the positional sensors 210) and responsively open the latch to release the connection between the hull 102 and the malfunctioning hydrofoil assembly. In some examples, the weight of the malfunctioning hydrofoil assembly is sufficient to jettison the malfunctioning hydrofoil assembly out of the hull 102 when the latch is opened. Some examples of the craft 100 include an actuator or some other mechanism to jettison the malfunctioning hydrofoil assembly out of the hull 102. In some examples, the main and/or rear hydrofoil assemblies 108, 110 are configured to break in a controlled manner upon impact with water. For instance, in some examples, a joint between the main hydrofoil strut 132 and the hull 102 and/or a joint between the rear hydrofoil strut 138 and the hull 102 is configured to disconnect when subjected to a torque significantly larger than standard operational torques at the joints. Other designs for providing controlled breaks are possible as well.

### F. Battery System

FIG. 4 illustrates an example of an onboard battery system. In some examples, a portion of the battery system 400 is arranged in a protected area 402 of the hull 102 below a passenger seating area 404. Some examples of the battery system 400 are separated from the passenger seating area 404 by a firewall 406 to protect the passengers from harm if a thermal runaway occurs. In this regard, some examples of the craft 100 include a battery management system comprising voltage, current, and/or thermal sensors for detecting thermal runaway or some other fire detection system for detecting a fire in the protected area 402.

Some examples of the craft 100 include one or more mechanisms for flooding the battery system 400 (e.g., with an inert gas fire, with water, etc.) upon detecting a thermal runaway or a fire in the protected area 402. For instance, some examples of the hull 102 comprise one or more valves or other controllable openings. The control system of the craft 100 is configured to open the valves and/or controllable openings upon detecting a fire in the protected area 402 or thermal runaway in the battery system 400 to allow water to enter the protected area 402 and to extinguish or prevent a fire in the protected area 402.

In some examples, the battery system 400 is configured to be jettisoned through one or more of the controllable openings in the hull 102 described above. In this regard, in some examples, the weight of the battery system 400 is sufficient to jettison the battery system 400 out of the hull 102 when the hull 102 is opened. In some examples, the craft 100 comprises an actuator or the like configured to jettison the battery system 400 out of the hull 102.

In other examples, the craft 100 may take measures to become waterborne in response to detecting a fire in the protected area 402 or thermal runaway in the battery system 400. Some examples of the control system of the craft 100 determine a fire suppression operation to perform based on the operational state of the craft 100 (e.g., operating in hull-borne, hydrofoil-borne, or wing-borne mode). For instance, when operating in hull-borne mode and upon detecting a thermal runaway or a fire in the protected area 402, some examples of the control system are configured to flood the battery system 400 as described above. When operating in hydrofoil-borne or a wing-borne mode, the control system is configured to cause the craft 100 to transition to hull-borne mode upon detecting a thermal runaway or a fire in the protected area 402 and then flood the battery system 400. Battery system 400 and example positioning of batteries of the battery system 400 are described in further detail below.

### G. Control System

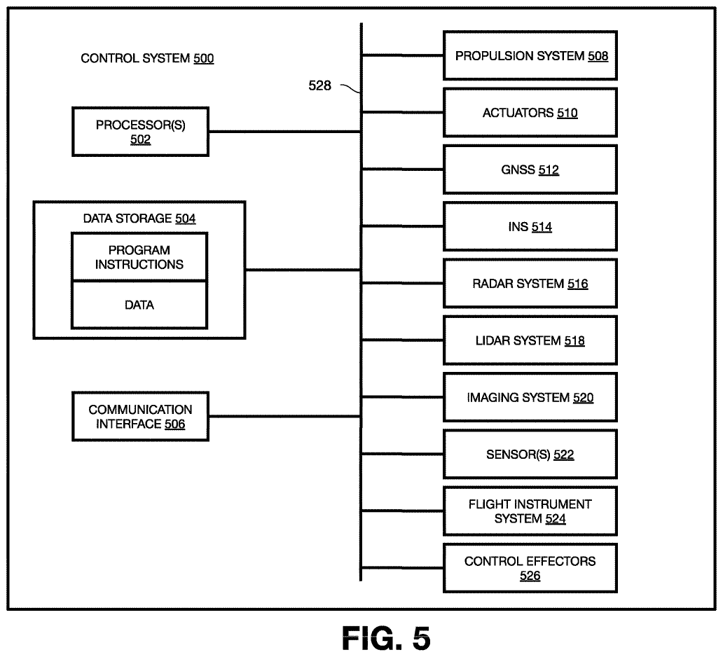

FIG. 5 illustrates an example of a control system 500 of the craft 100. As shown, some examples of control system 500 include one or more processors 502, data storage 504, a communication interface 506, a propulsion system 508, actuators 510, a Global Navigation

Satellite System (GNSS) 512, an inertial navigation system (INS) 514, a radar system 516, a lidar system 518, an imaging system 520, various sensors 522, a flight instrument system 524, and flight controls 526. In some examples, some or all of these components communicate with one another via one or more communication links 528 (e.g., a system bus, a public, private, or hybrid cloud communication network, etc.)

Some examples of processors 502 correspond to or comprise general-purpose processors (e.g., a single- or multi-core microprocessor), special-purpose processors (e.g., an application-specific integrated circuit or digital-signal processor), programmable logic devices (e.g., a field-programmable gate array), controllers (e.g., microcontrollers), and/or any other processor components now known or later developed. Further, while the one or more processors 502 are illustrated as a separate stand-alone component of the control system 500, it should also be understood that the one or more processors 502 could comprise processing components that are distributed across one or more of the other components of the control system 500.

Some examples of the data storage 504 comprise one or more non-transitory computer-readable storage mediums that are collectively configured to store (i) program instructions executable by the one or more processors 502 such that the control system 500 is configured to perform some or all of the functions disclosed herein, and (ii) data that may be received, derived, or otherwise stored, for example, in one or more databases, file systems, or the like, by the control system 500 in connection with the functions disclosed herein. In this respect, the one or more non-transitory computer-readable storage mediums of data storage 504 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. Further, while the data storage 504 is illustrated as a separate stand-alone component of the control system 500, it should also be understood that the data storage 504 may comprise computer-readable storage mediums that are distributed across one or more of the other components of the control system 500.

Some examples of the communication interface 506 include one or more wireless interfaces and/or one or more wireline interfaces, which allow the control system 500 to communicate via one or more networks. Some example wireless interfaces provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Some example wireline interfaces include an Ethernet interface, a Universal Serial Bus (USB) interface, CAN Bus, RS-485, or similar interface to communicate via a wire, a twisted pair of wires, a coaxial cable, an optical link, a fiber-optic link, or other physical connection to a wireline network.

Some examples of the propulsion system 508 include one or more electronic speed controllers (ESCs) for controlling the electric motor propeller assemblies 116 distributed across the main wing 104 and, in some examples, across the horizontal stabilizer 124. Some examples of the propulsion system 508 include a separate ESC for each respective propeller assembly 116, such that the control system 500 individually controls the rotational speeds of the electric motor propeller assemblies 116.

Some examples of the actuators 510 include any of the actuators described herein, including (i) actuators for raising and lowering the flaps 118, ailerons 120, elevators 126, main hydrofoil control surfaces 134, and rear hydrofoil control surfaces 140, (ii) actuators for turning the rudder 128, the main hydrofoil control surfaces 134 positioned on the main hydrofoil strut 132, and the rear hydrofoil control surfaces 140 positioned on the rear hydrofoil strut 138, (iii) actuators for retracting and extending the main hydrofoil assembly 108 and the rear hydrofoil assembly 110, and/or (iv) actuators for performing the various other disclosed actuations of the main hydrofoil assembly 108 and the rear hydrofoil assembly 110. Each of the actuators described herein may include any actuators now known or later developed capable of performing the disclosed actuation. Some examples of the actuators correspond to linear actuators, rotary actuators, hydraulic actuators, pneumatic actuators, electric actuators, electro-hydraulic actuators, and mechanical actuators. Some examples of the actuators correspond to electric motors, stepper motors, and hydraulic cylinders. Other examples are contemplated herein as well.

Some examples of the GNSS system 512 are configured to provide a measurement of the location, speed, altitude, and heading of the craft 100. The GNSS system 512 includes one or more radio antennas paired with signal processing equipment. Data from the GNSS system 512 may allow the control system 500 to estimate the position and speed of the craft 100 in a global reference frame, which can be used for route planning, operational envelope protection, and vehicle traffic deconfliction by both understanding where the craft 100 is located and comparing the location with known traffic.

Some examples of the INS 514 include motion sensors, such as angular and/or linear accelerometers, and rotational sensors, such as gyroscopes, to calculate the position, orientation, and speed of the craft 100 using dead reckoning techniques. In some examples, one or more of these components are used by the control system to calculate actuator outputs to stabilize or otherwise control the vehicle during all modes of operation.

Some examples of the radar system 516 include a transmitter and a receiver. The transmitter may transmit radio waves via a transmitting antenna. The radio waves reflect off an object and return to the receiver. The receiver receives the reflected radio waves via a receiving antenna, which may be the same antenna as the transmitting antenna, and the radar system 516 processes the received radio waves to determine information about the object's location and speed relative to the craft 100. This radar system 516 may be utilized to detect, for example, the water surface, maritime or wing-borne vehicle traffic, wildlife, or weather.

Some examples of the lidar system 518 comprise a light source and an optical receiver. The light source emits a laser that reflects off an object and returns to the optical receiver. The lidar system 518 measures the time for the reflected light to return to the receiver to determine the distance between the craft 100 and the object. This lidar system 518 may be utilized by the flight control system to measure the distance from the craft 100 to the surface of the water in various spatial measurements.

Some examples of the imaging system 520 include one or more still and/or video cameras configured to capture image data from the environment of the craft 100. Some examples of the cameras correspond to or comprise charge-coupled device (CCD) cameras, complementary metal-oxide-semiconductor (CMOS) cameras, short-wave infrared (SWIR) cameras, mid-wave infrared (MWIR) cameras, or long-wave infrared (LWIR) cameras. Some examples of the imaging system 520 are configured to perform obstacle avoidance, localization techniques, water surface tracking for more accurate navigation (e.g., by applying optical flow techniques to images), video feedback, and/or image recognition and processing among other possibilities.

As noted above, some examples of the control system 500 include various other sensors 522 for use in controlling the craft 100. Examples of such sensors 522 correspond to or comprise thermal sensors or other fire detection sensors for detecting a fire in the hull 102 or for detecting thermal runaway in the battery system 400. As further described above, the sensors 522 may include position sensors for sensing the position of the main hydrofoil assembly 108 and/or the rear hydrofoil assembly 110 (e.g., sensing whether the assemblies are in a retracted or extended position). Examples of position sensors may include photodiode sensors, capacitive displacement sensors, eddy-current sensors, Hall effect sensors, inductive sensors, or any other position sensors now known or later developed.

Some examples of the sensors 522 facilitate determining the altitude of the craft 100. For instance, some examples of the sensor 522 include an ultrasonic altimeter configured to emit and receive ultrasonic waves. The emitted ultrasonic waves reflect off the water surface below the craft 100 and return to the altimeter. The ultrasonic altimeter measures the time for the reflected ultrasonic wave to return to the altimeter to determine the distance between the craft 100 and the water surface. Some examples of the sensor 522 include a barometer for use as a pressure altimeter. The barometer measures the atmospheric pressure in the environment of the craft 100 and determines the altitude of the craft 100 based on the measured pressure. Some examples of the sensor 522 include a radar altimeter to emit and receive radio waves. The radar altimeter measures the time for the radio wave to reflect off of the surface of the water below the craft 100 to determine a distance between the craft 100 and the water surface. In some examples, these sensors are placed in different locations on the craft 100 to reduce the impact of sensor constraints, such as sensor deadband or sensitivity to splashing water.

Some examples of the control system 500 are configured to use one or more of the sensors 522 or other components of the control system 500 to help navigate the craft 100 through maritime traffic or to avoid any other type of obstacle. For example, some examples of the control system 500 determine the position, orientation, and speed of the craft 100 based on data from the INS 514 and/or the GNSS 512, and the control system 500 may determine the location of an obstacle, such as a maritime vessel, a dock, or various other obstacles, based on data from the radar system 516, the lidar system 518, and/or the imaging system 520. Some examples of the control system 500 determine the location of an obstacle using the Automatic Identification System (AIS). Some examples of the control system 500 are configured to maneuver the craft 100 to avoid collision with an obstacle based on the determined position, orientation, and speed of the craft 100 and the determined location of the obstacle by actuating various control surfaces of the craft 100 in any of the manners described herein.

Some examples of the flight instrument system 524 include instruments for providing data about the altitude, speed, heading, orientation (e.g., yaw, pitch, and roll), battery levels, or any other information provided by the various other components of the control system 500.

Some examples of the flight controls 526 include one or more joysticks, thrust control levers, buttons, switches, dials, levers, or touch screen displays, etc. In operation, a pilot may use the flight controls 526 to operate one or more control surfaces (e.g., flaps, ailerons, elevators, rudder, propulsion propellers, etc.) of the craft 100 to thereby maneuver the craft 100 (e.g., control the direction, speed, altitude, etc., of the craft 100)

In some examples, the combinations of control surfaces on the craft 100 used by the control system 500 to control operations of the craft 100 depends on the mode of operation of the craft 100 and is determined based at least in part on aspects such as vehicle position, speed, attitude, acceleration, rotational rates, and/or altitude above water. Table 1 summarizes an example of the relationship between the control surfaces and the operation mode.

TABLE 1

| Control Surface | Hull-borne | Foil-borne | Wing-borne |
|---|---|---|---|
| Propulsion | Y | Y | Y |
| Aerodynamic | N | Y | Y |
| Elevator | | | |
| Aerodynamic | N | Y | Y |
| Ailerons | | | |
| Aerodynamic | Y | Y | Y |
| Rudder | | | |
| Aerodynamic | N | Y | Y |
| Flaps | | | |
| Hydrodynamic | Y | Y | N |
| Elevator | | | |
| Hydrodynamic | Y | Y | N |
| Flaps | | | |
| Hydrodynamic | Y | Y | N |
| Rudder | | | |

In some examples, the propulsion control surfaces in the table include the propeller assembly 116, as well as any propellers mounted to the hull 102, main hydrofoil assembly 108, or rear hydrofoil assembly 110. In some examples, the aerodynamic elevator control surfaces include elevator 126, the aerodynamic ailerons include ailerons 120, the aerodynamic rudder includes rudder 128 (when not submerged), the aerodynamic flaps include flaps 118, the hydrodynamic elevator includes rear hydrofoil control surfaces 140, the hydrodynamic flaps include main hydrofoil control surfaces 134, and the hydrodynamic rudder includes rudder 128 (when submerged).

In some examples, when actuating the control surfaces in the various examples, operational modes identified in Table 1 above, the control system 500 executes different levels of stabilization along the various vehicle axes during different modes of operation. Table 2-1 and Table 2-2 below identify alternative examples of stabilization controls that the control system 500 applies during the various modes of operation for each axis of the craft 100. Closed-loop control may comprise feedback and/or feed-forward control.

TABLE 2-1

| Vehicle | | | |
|---|---|---|---|
| Axis | Hull-borne | Foil-borne | Wing-borne |
| Pitch Axis | None | Closed-loop | Closed-loop |
| | | control on | control on |
| | | vehicle ride | vehicle |
| | | height | altitude |
| Roll Axis | None | Closed-loop | Stabilization |
| | | control around | and closed-loop |
| | | vehicle bank | control on |
| | | angle = 0 | heading |
| Yaw Axis | Rate | Closed-loop | Closed-loop |
| | stabilization | control on | control on |
| | | vehicle | vehicle |
| | | heading | heading |
| Speed | Closed-loop | Closed-loop | Closed-loop |
| Control | control on | control on | control on |
| | vehicle GPS | vehicle GPS | vehicle |
| | Speed | Speed | airspeed |

TABLE 2-2

| | Hull-borne | Hull-borne | | |
|---|---|---|---|---|
| | (E.g., | (E.g., | | |
| Vehicle | Speed < | Speed > | | |
| Axis | 7 knots) | 7 knots) | Foil-borne | Wing-borne |
| Pitch Axis | None | Closed-loop | Closed-loop | Closed-loop |
| | | pitch control | control on | control on |
| | | | vehicle ride | vehicle |
| | | | height | altitude |
| Roll Axis | None | None | Closed-loop | Stabilization |
| | | | control around | and closed-loop |
| | | | vehicle bank | control on |
| | | | angle = 0 | heading |
| Yaw Axis | Rate | Rate | Closed-loop | Closed-loop |
| | stabilization | stabilization | control on | control on |
| | | | vehicle | vehicle |
| | | | heading | heading |
| Speed | Closed-loop | Closed-loop | Closed-loop | Closed-loop |
| Control | control on | control on | control on | control on |
| | vehicle GPS | vehicle GPS | vehicle GPS | vehicle |
| | Speed | Speed | Speed | airspeed |

Further, in some examples, the control system 500 is configured to actuate different control surfaces to control the movement of the craft 100 about its different axes. Table 3 below identifies example axial motions that are affected by the various control surfaces of the craft 100.

TABLE 3

| Control Surface | Axis Control Function |
|---|---|
| Propulsion | (a) accelerate and decelerate the |
| | vehicle |
| | (b) turn the vehicle about yaw axis |
| | (c) create a rolling moment |
| Aerodynamic Elevator | (a) create a pitch up or pitch down |
| | moment |
| Aerodynamic Ailerons | (a) create a rolling moment |
| | (b) increase lift on aerodynamic |
| | wing |
| | (c) create a pitch-down moment |
| Aerodynamic Rudder | (a) create a yawing moment |
| Aerodynamic Flaps | (a) increase lift on aerodynamic |
| | wing |
| | (b) create a pitch-down moment |
| Hydrodynamic Elevator | (a) create a pitch moment |
| | (b) generate heave force on rear |
| | hydrofoil |
| Hydrodynamic Flaps | (a) generate heave force on main |
| | hydrofoil |
| Hydrodynamic Rudder | (a) create a yaw moment |

### III. Example Modes of Operation

### A. Hull-Borne Operation

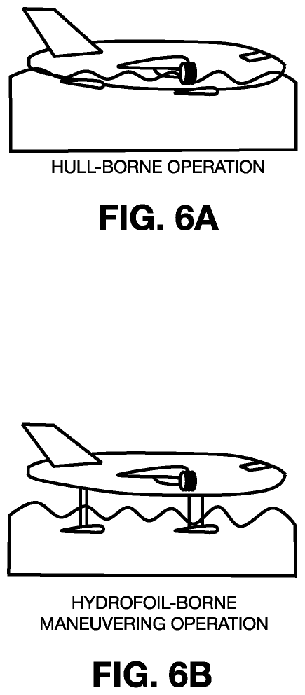

FIG. 6A illustrates an example of the craft 100 when the craft 100 is operating in a hull-borne mode. During this mode, the craft 100 is docked and floating on the hull 102, with the buoyancy of the outriggers 114 providing for roll stabilization of the craft 100. While docked, the battery system 400 of the craft 100 may be charged. In some examples, rapid charging is aided by an open or closed-loop water-based cooling system. In some examples, the surrounding body of water is used in the loop or as a heat sink. In some examples, the craft 100 includes a heat sink integrated into the hull 102 for exchanging heat from the battery system 400 to the surrounding body of water. In other examples, the heat sink is located offboard in order to reduce the mass of the craft 100.

Additionally, in some examples, the propeller assemblies 116 are folded in a direction away from the dock while the craft 100 is docked to help avoid collision with nearby structures or people. This folding may be actuated in various ways, such as by metal spring force, hydraulic pressure, electromechanical actuation, or centrifugal force due to propeller rotation. Other examples are possible as well. Further, in some examples, the main hydrofoil assembly 108 and the rear hydrofoil assembly 110 are retracted (or partially retracted) to avoid collisions with nearby underwater structures.

In some examples, when the craft 100 is ready to depart, the craft 100 uses its propulsion systems, including the propeller assemblies 116 and/or the underwater propulsion system (e.g., one or more outrigger propulsion systems, one or more propeller pods mounted to the hull 102, the main hydrofoil assembly 108, and/or the rear hydrofoil assembly 110), to maneuver away from the dock while remaining hull-borne. In some examples, the main hydrofoil assembly 108 and the rear hydrofoil assembly 110 remain retracted (or partially retracted) during this maneuvering to reduce the risk of hitting underwater obstacles near docks or in shallow waterways. However, when there is a limited risk of hitting underwater obstacles, the craft 100 may partially or fully extend the main hydrofoil assembly 108 and/or the rear hydrofoil assembly 110. With the main hydrofoil assembly 108 and/or the rear hydrofoil assembly 110 extended, the craft 100 actuates the main hydrofoil control surfaces 134 and/or the rear hydrofoil control surfaces 140 to improve maneuverability as described above.

In some examples, at low speeds during hull-borne operation, the control system 500 controls the position and/or rotation of the craft 100 by causing all of the propeller assemblies 116 to spin at the same idle speed, but with a first subset spinning in a forward direction and a second subset spinning in a reverse direction. For instance, in some examples, the control system 500 causes propeller assemblies 116a, 116c, 116e, 116h, 116j, and 116l to idle in reverse and propeller assemblies 116b, 116d, 116f, 116g, 116i, and 116k to idle forward. In this arrangement, the control system 500 causes the craft 100 to make various maneuvers without having to change the direction of rotation of any of the propeller assemblies 116. For instance, to induce a yaw on the craft 100, in some examples, the control system 500 increases the speed of the reverse propeller assemblies on one side of the main wing 104 while increasing the speed of the forward propeller assemblies on the other side of the main wing 104 and without causing any of the propeller assemblies to transition from forward to reverse or from reverse to forward. For example, idling the propellers at a nominal RPM may allow for a faster response in generating a yaw moment on the craft 100 because the propellers required for generating the yaw moment do not have to increase from zero RPM to the desired RPM value. They can spin from the idle RPM to the desired RPM value.

### B. Foil-Borne Maneuvering Operation

FIG. 6B illustrates an example of the craft 100 when the craft 100 is operating in hydrofoil-borne maneuvering mode. During this mode, the craft 100 is configured to, for example, move through harbors and crowded waterways at speeds generally between 20-45 mph. In this regard, the craft 100 may extend the main hydrofoil assembly 108 and the rear hydrofoil assembly 110 (if not already extended) and accelerate using the previously described propulsion system towards a desired takeoff speed. During acceleration, the craft 100 reaches a speed at which the main hydrofoil assembly 108 and the rear hydrofoil assembly 110 alone support the weight of the craft 100, and the hull 102 is lifted above the surface of the water (e.g., by 3-5 ft) so that the hull is clear of any surface waves. After the hull 102 leaves the surface of the water, the drag forces exerted on the craft 100 drop significantly, and the amount of thrust required to maintain acceleration can be reduced. Therefore, in some examples, after the hull 102 has left the water, the control system 500 reduces the speed of the propeller assemblies 116 to lower the thrust of the craft 100.

Some examples of the control system 500 sustain this operational mode by actively controlling the pitch and speed of the craft 100 so that the main hydrofoil assembly 108 and the rear hydrofoil assembly 110 continue to entirely support the weight of the craft 100. In this regard, some examples of the control system 500 actuate the main hydrofoil control surfaces 134 and/or the rear hydrofoil control surfaces 140 and/or the propulsion system to stabilize the attitude of the craft 100 to maintain the desired height above the surface of the water, vehicle heading, and vehicle forward speed. In this regard, some examples of the control system 500 are configured to detect various changes in the yaw, pitch, or roll of the craft 100 based on data provided by the INS 514 and to make calculated actuations of the main hydrofoil control surfaces 134 and/or the rear hydrofoil control surfaces 140 to counteract the detected changes.

### C. Foil-borne Takeoff Operation

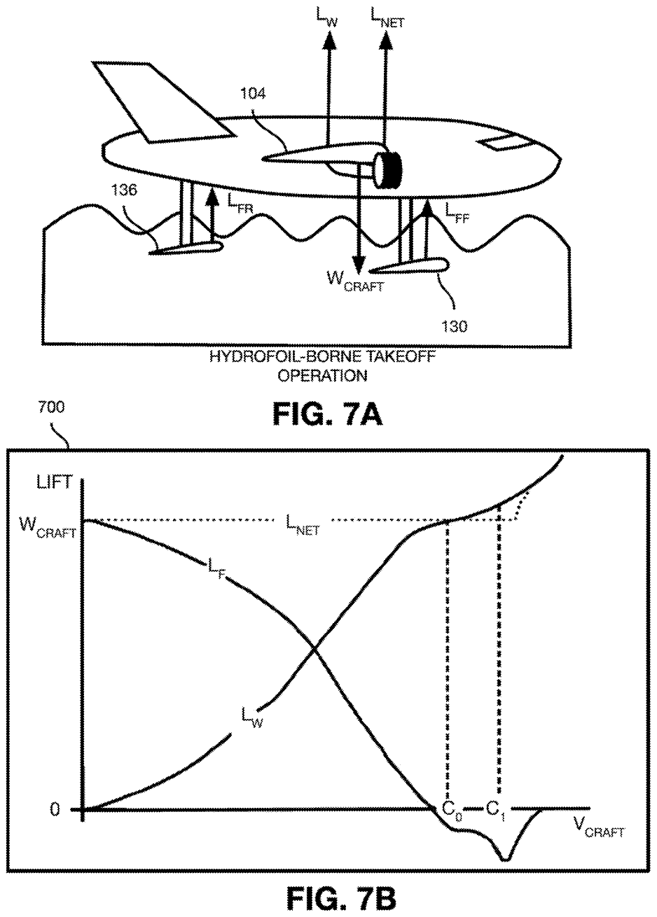

FIG. 7A illustrates an example of the craft 100 when the craft 100 is operating in hydrofoil-borne takeoff mode. During this mode, the craft 100 is configured to, for example, move through open waters and obtain speeds generally between 40-50 mph to facilitate generating the lift required to become wing-borne.

Referring to FIG. 7A, aero lift, LW, generally represents the lift generated by the main wing 104 of the craft 100 but can also include the lift generated by other surfaces such as the tail wing, hull, or propulsive devices such as propellers, rotors, jets, etc. LF generally corresponds to the lift generated by one or more hydrofoils 130, 136 of the craft 100, where LFF corresponds to the lift generated by the front foil and the LFR corresponds to the lift generated by the rear foil. WCRAFT corresponds to the force of gravity exerted on the craft 100 and is also referred to as the weight of the craft. During steady state operation, WCRAFT generally corresponds to LW+LFR+LFF which also corresponds to LNET. Throughout the description, the term LF is generally understood to correspond to LFR+LFF.

Some experimental craft developed by Applicant that include aero foils were unable to achieve the lift required to sustain flight. In these experimental craft, in an attempt to become airborne, the craft 100 would ramp up to a speed at which point the hydrofoil would breach the surface of the water, as WCRAFT<Lw+LF, and LF>0, resulting in Lw<WCRAFT. However, in order to takeoff from the water's surface, the aero lift must be greater than or equal to the weight of the craft, however prior to takeoff, the hydrofoils are still under the water's surface, and up until takeoff, have been generating lift (LF>0) as the aerodynamic lift has been insufficient for takeoff up until this point. If the hydro lift and the aero lift sum to greater than the weight of the craft, the vehicle will accelerate upwards and potentially create a premature takeoff condition (prior to condition C0 in FIG. 7B) as the aero lift, LW, generated by the wings, etc., of the craft 100 would be insufficient to sustain flight, and, as a result, the craft 100 would come back down and breach the water, ultimately preventing takeoff. The techniques disclosed below ameliorate these problems by controlling the hydrofoil lift vector, LF, specifically by generating downward forces of one or more hydrofoils 130, 136 of the craft 100 to keep the hydrofoils 130, 136 submerged until after the upwards aero lift, LW, is sufficient to allow the craft 100 to sustain flight.

In some examples, the lift LF is in the downward direction, and is introduced via the hydrofoil(s) as LW increases beyond WCRAFT while the craft 100 is increasing in speed in anticipation of takeoff. This allows the craft 100 to generate a greater overall aero lift, LW, prior to actual takeoff than would otherwise be possible. Then, at the appropriate time (e.g., when LW reaches some predetermined threshold such as the weight of the craft 100 or some margin thereof), the negative lift, LF, can be “released” from the craft 100, and the craft 100 can, as a result, proceed to become wing-borne.

FIG. 7B is an example of a graph 700 that relates these aspects. The relationships shown in the graph 700 and the ways in which various lift forces, thresholds, etc., are depicted are merely examples and are provided to aid understanding of the various operations and procedures described herein. As shown, the net lift, LNET, on the craft 100 initially corresponds to the combination of the aero lift, LW, generated by the wing (e.g., main wing, tail wing, etc.) and the lift, LF, generated by the hydrofoils 130, 136 (e.g., LNET=LW+LF). On the left side of the graph 700, the speed of the craft 100 is such that LNET is sufficient to allow the craft 100 to operate in hydrofoil-borne maneuvering mode but is insufficient to allow the craft 100 to become wing-borne. Moving to the right of the graph 700 as speed increases, LW increases with increased craft 100 water speed. To maintain ride height and prevent the hydrofoils 130, 136 from breaching the water surface, LF is reduced in proportion to an increase in LW. For example, LF is adjusted with the speed of the craft 100 to maintain LNET at a margin equal to the weight, WCRAFT, of the craft 100, or small deviations about equal to control ride height. The overall lift provided by the hydrofoils 130, 136 may decrease at the same rate at which lift from the wing is increased towards zero or even become negative with increased speed. For example, just before the speed of the craft 100 reaches the speed associated with condition C0, LF may be reduced to zero. The conditions at C0 (e.g., speed of the craft 100, angle of attack of craft 100, deflection angles of control surfaces, angle of incidence of hydrofoils, etc.) may be such that LF may be zero or close to zero. At C0, the aero lift, LW, generated by the main wing 104 may be expected to be able to transition the craft 100 to a wing-borne mode of operation if the downwards hydrofoil lift, LF, were to be removed as LW=WCRAFT. Accordingly, at some time and/or increased speed after this point (e.g., speed associated with condition C1) where LW>WCRAFT, LF may be gradually or abruptly removed/released. This, in turn, allows LNET to approximately equal to or greater than WCRAFT which allows the craft 100 to take off and become wing-borne.

While not shown in the graph, in some examples, LF is not removed/released as described. Rather, as the craft 100 continues to accelerate, the downwards hydrofoil lift, LF, increases to a maximum downwards amount (e.g., a predetermined maximum amount and/or a maximum amount achievable due to the limitations of the control capabilities of the hydrofoil). As the aero lift, LW, generated by the main wing 105 continues to increase past this maximum amount of downwards hydrofoil lift, LF, LNET increases in the upwards direction beyond WCRAFT and the craft 100 is pulled from the water. This, in turn transitions the craft 100 to a wing-borne mode of operation.

### D. Wing-Borne Operation

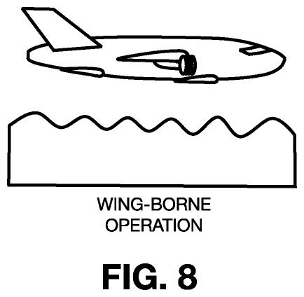

FIG. 8 illustrates an example of the craft 100 after becoming wing borne. In some examples, once the transition from hydrofoil-borne operation to wing-borne operation is complete, the control system 500 causes the main hydrofoil deployment system 200 and the rear hydrofoil deployment system 300 to respectively retract the main hydrofoil assembly 108 and the rear hydrofoil assembly 110. In some examples, the control system 500 initiates this retraction as soon as the hydrofoil assemblies 108, 110 are clear of the water to reduce the chance of the hydrofoil assemblies 108, 110 reentering the water. The control system 500 may determine that the hydrofoil assemblies 108, 110 are clear of the water in various ways. For instance, in an example, the control system 500 makes such a determination based on a measured altitude of the craft 100 (e.g., based on data provided by the radar system 516, the lidar system 518, and/or the other sensors 522 described above for measuring an altitude of the craft 100). In another example, the sensors 522 may further include one or more conductivity sensors, temperature sensors, pressure sensors, strain gauge sensors, or load cell sensors arranged on the hydrofoil assemblies 108, 110, and the control system 500 may determine that the hydrofoil assemblies 108, 110 are clear of the water-based on data from these sensors.

Once the craft 100 is clear of the water, the control system 500 continues to accelerate the craft 100 to the desired cruise speed by controlling the speed of the propeller assemblies 116. In some examples, the control system 500 retracts the flap systems when the craft 100 has achieved sufficient airspeed to generate enough lift to sustain altitude without them and actuates various control surfaces of the craft 100 and/or applies differential thrust to the propeller assemblies 116 to perform any desired maneuvers, such as turning, climbing, or descending, and to provide efficient lift distribution. While in wing-borne mode, the craft 100 can fly both low over the water's surface in ground-effect or above ground-effect depending on operational conditions and considerations.

### E. Return to Hull-Borne Operation

To facilitate transitioning from wing-borne to hull-borne mode of operation (See FIG. 6A), the control system 500 determines that the hydrofoil assemblies 108, 110 are fully or partially retracted so that the craft 100 may safely land on its hull 102. In some examples, the control system 500 additionally determines and suggests the desired landing direction and/or location-based on observed, estimated, or expected water surface conditions (e.g., based on data from the radar system 516, the lidar system 518, the imaging system 520, or other sensors 522).

The control system 500 initiates deceleration of the craft 100, for instance, by reducing the speeds of the propeller assemblies 116 until the craft 100 reaches a desired landing airspeed. During the deceleration, the control system 500 may deploy the flaps 118 to increase lift at low airspeeds and/or to reduce the stall speed. Once the craft 100 reaches the desired landing airspeed (e.g., approximately 50 knots), the control system 500 reduces the descent rate (e.g., to be less than approximately 200 ft/min). As the craft 100 approaches the surface of the water (e.g., once the control system 500 determines that the craft 100 is within 5 feet of the water surface), the control system 500 further slows the descent rate to cushion the landing (e.g., to be less than approximately 50 ft/min). As the hull 102 of the craft 100 impacts the surface of the water, the control system 500 reduces thrust, and the craft 100 rapidly decelerates due to the presence of hydrodynamic drag, the reduction in forward thrust, and the reduction or elimination of blowing air over the wing which significantly reduces lift causing the vehicle to settle into the water. The hull 102 settles into the water as the speed is further reduced until the craft 100 is stationary.

In some examples, after the craft 100 is settled in the water, the craft 100 is transitioned back to hydrofoil-borne maneuvering mode (See FIG. 6B) by extending the hydrofoil assemblies 108, 110 to transition from hull-borne operation to hydrofoil-borne operation in the same manner as described above. In some examples, the control system 500 then sustains the hydrofoil-borne mode at the fifth stage and maneuvers the craft 100 into port while keeping the hull 102 insulated from surface waves. The control system 500 then reduces the thrust generated by the propeller assemblies 116 to lower the speed of the craft 100 until the hull 102 settles into the water, thereby transitioning that craft back to hull-borne operation at the sixth stage. The control system 500 then retracts the hydrofoil assemblies 108, 110 and performs the hull-borne operations described above to maneuver the craft 100 into a dock for disembarking passengers or goods and recharging the battery system 400.

### IV. Existing Approaches for Performing Wing Bend Tests

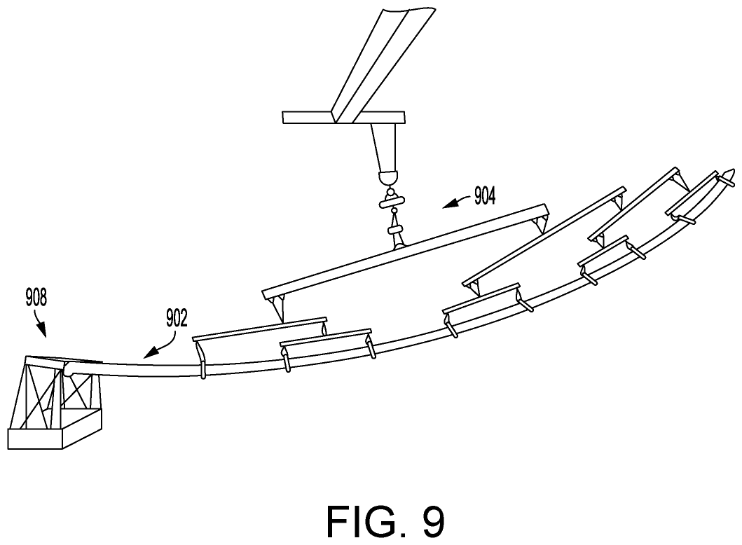

FIG. 9 depicts an example of an existing wiffle tree for performing wing bend tests. As shown in FIG. 9, a wing 902 is suspended in the air by a whiffle tree 904, wherein the wing 902 is attached to the whiffle tree 904 at a set of contact points along the length of the wing 902. Further, the proximate end of the wing 902 is anchored to a brace 908. As described above, utilizing wiffle trees or other actuator-based approaches for performing wing bend tests leads to various impracticalities, risks, and expenses, among other shortcomings. These shortcomings may be more pronounced when performing wing bend tests for certain wings, e.g., which may comprise a single structural spar manufactured from carbon fiber over a foam core. The inherent design characteristics of such a wing-including, for example, a relatively thin outer skin and a lack of readily available hardpoints-underscore the limitations of traditional approaches for performing wing bend tests and highlight the critical need for a more adaptable, cost-effective, and precise solution.

### V. Example Approach for Performing Wing Bend Tests

As discussed above, the present disclosure is directed towards a new approach for performing wing bend tests. Within examples, the approach involves utilizing a plurality of inflatable bags. As described in greater detail herein, the new approach may be used for wings of various types and of various vehicles, including the multimodal craft described above in connection with FIGS. 1-8, among other possible craft, as well as for wings in different states of installment, including when the wing is detached from a vehicle and when the wing is attached to a vehicle (e.g., at the vehicle's hull).

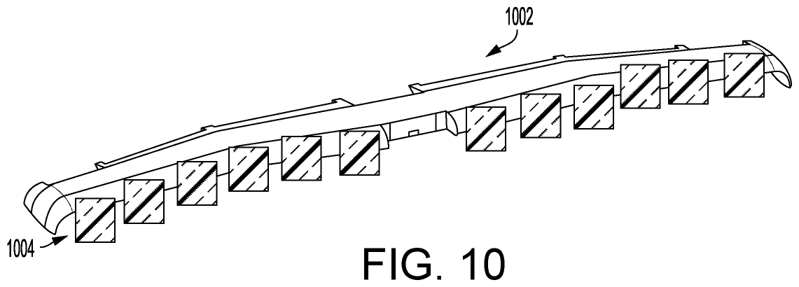

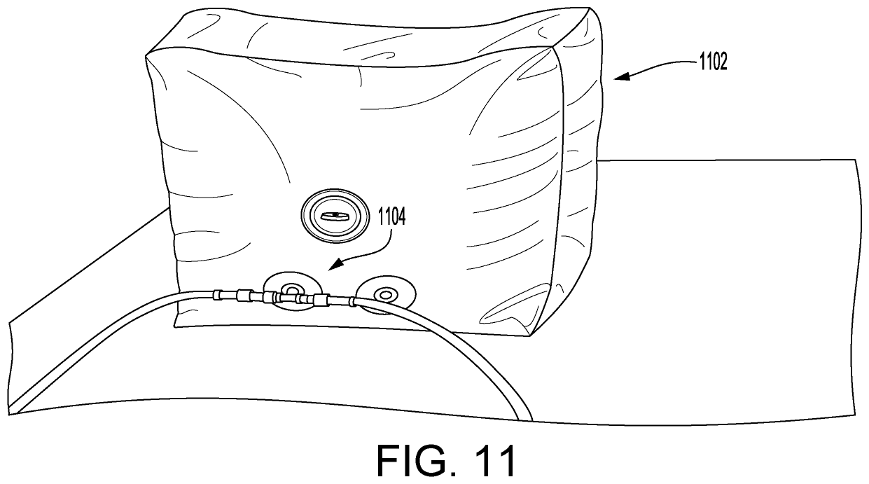

Turning now to FIG. 10, a wing 1002 is shown, as well as a plurality of inflatable bags 1004, which may be utilized to perform wing bend tests on the wing 1002 according to the disclosed approach.

The wing 1002 may take various forms. In line with the discussion above, the disclosed approach may be of particular value for performing wing bend tests on wings with relatively thin outer skins, however, in practice, the disclosed approach may be used on other types of wings as well. As shown, a middle portion of the wing 1002 may be configured to attach to the hull of a vehicle, so that the wing 1002 extends to either side of the vehicle. However, in line with the discussion above, the wing 1002 may take other forms as well.

The wing 1002 may be in various states of installment when the wing bend test is performed. As one possibility, the wing 1002 may be detached from a vehicle when the wing bend test is performed.

When the wing 1002 is detached, the wing 1002 may be anchored to a test fixture, such as a rig (not shown) in order to stabilize the wing 1002 and keep the wing 1002 from being displaced when an upward force is applied to the wing 1002 (e.g., by a plurality of inflatable bags, as described below). The test fixture may take any suitable form. In a first example, the test fixture may include a sufficiently heavy implement that sits atop the ground. In a second example, the test fixture may include an implement that is rigidly attached to and/or made integral with a surrounding structure or facility (such as a poured ground or foundation of the facility). Other examples exist.

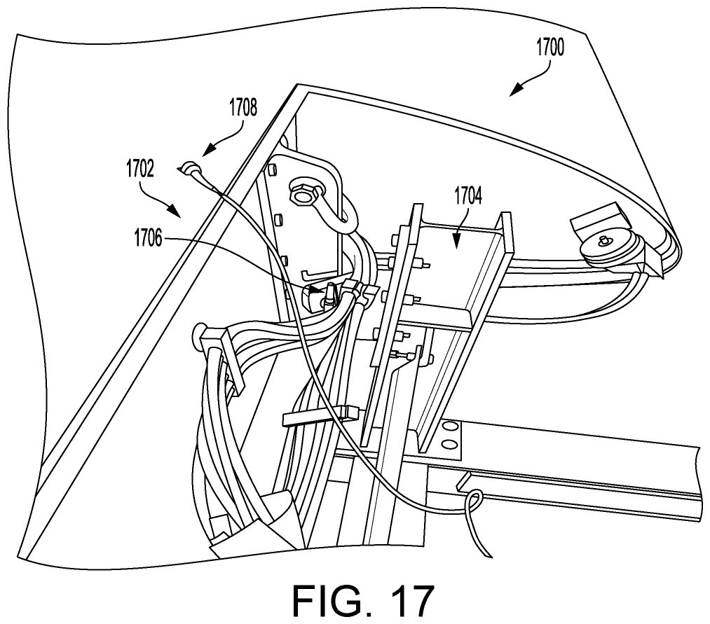

The wing 1002 may be anchored to the test fixture in various ways. In some implementations, the wing 1002 may be anchored to the test fixture via one or more load pins, which may be configured to measure the amount of force acting on the wing 1002. The wing 1002 may be anchored to the test fixture in other ways as well. Further details regarding load pins are included below with respect to FIG. 17.

Further, the wing 1002 may be anchored to the test fixture at various positions of the wing 1002. In some implementations, the wing 1002 may be anchored to the test fixture at a middle portion of the wing 1002, e.g., in implementations where the wing 1002 is configured to attach to a vehicle at a middle portion of the wing 1002. In other implementations, the wing 1002 may be anchored to the test fixture at a proximate end of the wing 1002. Other implementations may also exist, including implementations where the wing 1002 is anchored to the test fixture at both a middle portion of the wing 1002 and a proximate end of the wing 1002, among other possible positions.

Further, in some implementations, a plurality of concrete barriers may be utilized to secure the wing.

As another possibility, the wing 1002 may be installed on a vehicle (e.g., an aircraft or other vehicle) when the wing bend test is performed. In line with the discussion above, this flexibility extends the new approach's utility across different stages of vehicle development and testing. Various other possibilities may also exist.

The plurality of inflatable bags 1004 may be inflated in order to apply an upward force to the underside of the wing 1002. The upward force applied to the underside of the wing 1002 may simulate various forces that may be experienced by the wing 1002, such as aerodynamic lift forces experienced by the wing 1002 in operation, such as during flight or other modes of operation (e.g., hull-mode, foil-mode, etc.), among other possible forces that may be experienced by the wing 1002. As described in greater detail below, upward forces may also be applied to the underside of the wing 1002 outside of what the wing 1002 is expected to experience during regular operation.

The plurality of inflatable bags 1004 may be positioned strategically along the length of the wing 1002. While FIG. 10 shows the plurality of inflatable bags 1004 being evenly distributed along the length of the wing 1002 (except for the middle portion of the wing 1002), the plurality of inflatable bags 1004 may be spaced in other ways as well. For instance, inflatable bags may be positioned at various predetermined locations, in order to apply tailored amounts of force to specific portions of the wing 1002. Such an approach may help better simulate desired conditions, such as, for example, particular aerodynamic lift forces experienced by the wing 1002 in certain circumstances during operation, among other possible lift forces.

Further, while FIG. 10 shows the plurality of inflatable bags 1004 being arranged in a single row, in some implementations, the plurality of inflatable bags 1004 may be arranged into multiple rows along the length of the wing 1002. As described in greater detail below, this may allow for torsion testing of the wing 1002.

Each of the plurality of inflatable bags 1004 may take various forms. For instance, the plurality of inflatable bags 1004 may be constructed from fiber-reinforced materials, although other materials may be used as well. Further, in some implementations, each of the plurality of inflatable bags 1004 may be constructed from the same (or a substantially similar) material, while in other implementations, different inflatable bags of the plurality of inflatable bags 1004 may be constructed from different materials.

Each of the plurality of inflatable bags 1004 may take various sizes and shapes. While cube-shaped inflatable bags are shown and described herein, it should be noted that other shapes may be utilized, e.g., depending on the geometry of the wing, the ground surface, wheels and/or hydrofoils attached to the wing, hull, and/or other elements of the craft. In some implementations, each of the plurality of inflatable bags 1004 may take the same (or a substantially similar) size and/or shape. For instance, each of the plurality of inflatable bags 1004 may have a wing contact area of approximately 450 mm×450 mm, and may have a height of 360 mm or greater (e.g., 450 mm). In other implementations, different inflatable bags of the plurality of inflatable bags 1004 may have different sizes and/or shapes.

The variability of the plurality of inflatable bags 1004 may allow for more adaptability and variety in creating various load distributions for performing wing bend tests. For instance, by using inflatable bags of various sizes, shapes, and placements, the disclosed approach for performing wing bend tests may simulate various load distributions. Further details regarding the various load distributions that may be simulated using the disclosed approach are described below.

In line with the description above, each of the plurality of inflatable bags 1004 may be designed to accommodate application of relatively low levels of pressure (corresponding, ultimately, to relatively low amounts of force applied to given area of contact with the wing), which may reduce the likelihood of damaging the wing 1002 during the wing bend test. For instance, the plurality of inflatable bags 1004 may be designed to accommodate levels of pressure in the range of 0.5-5.0 PSI, although other pressure levels may be possible as well.

In some implementations, each of the plurality of inflatable bags 1004 may be equipped with a slip-resistant material on the outside surface of the inflatable bag (e.g., on a top outside surface of the inflatable bag, among other portions of the outside surface of the inflatable bag). In some implementations, the inflatable bag may be constructed from the slip-resistant material, while in other implementations, the slip-resistant material may be placed on or otherwise attached to the inflatable bag's outside surface. The slip-resistant material may take various forms, such as neoprene or possibly double-sided tape, among other examples of slip-resistant material, and may help ensure effective load transfer to the wing 1002 and prevent slippage.

In some implementations, the bottom of each of the plurality of inflatable bags 1004 may be secured to a surface (e.g., the floor or possibly a platform, as described in greater detail below). For instance, each of the plurality of inflatable bags 1004 may be secured to the surface via straps, among other examples.

The plurality of inflatable bags 1004 may take other forms as well.

FIG. 11 shows one example of an inflatable bag 1102 that may be utilized to apply an upward force to a wing according to the present disclosure. The inflatable bag 1102 may take various forms, in line with the discussion above.

As shown, the inflatable bag 1102 has been inflated, which may be accomplished in various ways. As one possibility, the inflatable bag 1102 may be inflated by filling the inflatable bag 1102 with air, such as, for example, using an air valve 1104 or the like. As another possibility, the inflatable bag 1102 may be inflated by filling the inflatable bag 1102 partially with a liquid (e.g., water) and partially with air. Other possibilities also exist.

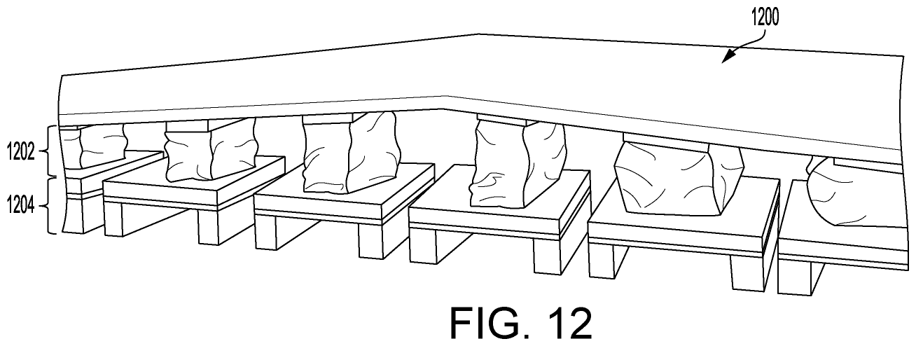

Turning now to FIG. 12, a wing 1200 is shown, which may be the same as or similar to the wing 1002 of FIG. 10. As shown in FIG. 12, a plurality of inflatable bags 1202—which may be the same as or similar to the plurality of inflatable bags 1004 of FIG. 10—are positioned along the length of the wing 1200, in line with the discussion above.

As shown in FIG. 12, a plurality of platforms 1204 may be used to elevate the plurality of inflatable bags 1202 so that the inflatable bags 1202 are able to make contact with the wing 1200. The plurality of platforms 1204 may have various heights to account for the varying height profile of the wing 1200. For instance, platforms positioned under lower portions of the wing 1200 may be lower than platforms positioned under more elevated portions of the wing 1200. Various other examples may also exist.

In implementations where the wing 1200 is detached from the wing's vehicle, the plurality of platforms 1204 may generally be close to the ground, e.g., to reduce the risk of fall damage to the wing 1200. However, in implementations where the wing 1200 is installed on a vehicle, the plurality of platforms 1204 may be elevated so that the plurality of inflatable bags 1202 are able to make contact with the wing 1200. In such implementations, the plurality of platforms 1204 may be elevated via a raised platform, a scaffold, or the like to position the plurality of inflatable bags 1202 near the bottom surface of the wing 1200. Other examples may also exist.

While in FIG. 12 multiple platforms are shown, such as a respective platform for each inflatable bag, this is not necessary. In an example, a given platform may support two or more inflatable bags.

In line with the discussion above, in order for the plurality of inflatable bags 1202 to apply an upward force to the wing 1200, the plurality of inflatable bags 1202 are inflated until a desired internal pressure at each inflatable bag is achieved. The relationship between the internal pressure of a given inflatable bag and the amount of upward force applied by the given inflatable bag to the wing 1200 may be defined by the formula:

$$F = P A$$

In this formula, the variable “F” represents the upward force applied by the given inflatable bag to the wing 1200, the variable “P” represents the internal pressure of the given inflatable bag, and the variable “A” represents the contact area between the given inflatable bag and the wing 1200.

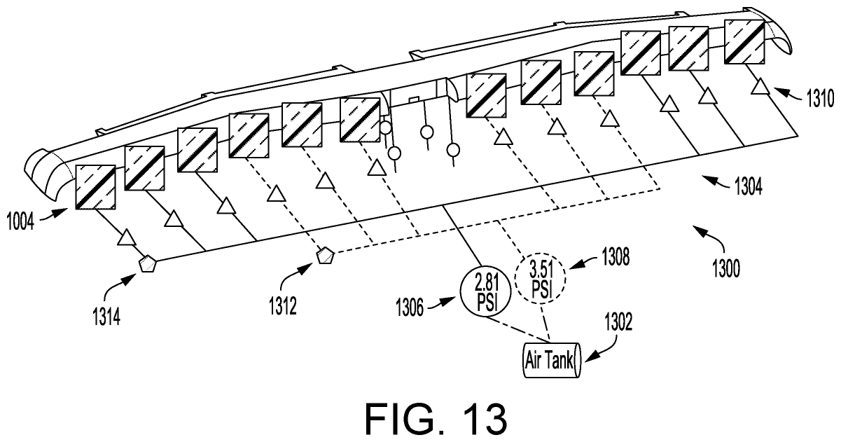

The pressure of the plurality of inflatable bags 1202 may be controlled in various ways. As one possibility, the pressure of the plurality of inflatable bags 1202 may be controlled utilizing an air-based pressure control technique. FIG. 13 shows an example air-based pressure control system 1300 together with the wing 1002 and the plurality of inflatable bags 1004 as shown shown in FIG. 10.

As shown, the example air-based pressure control system 1300 includes an air tank 1302 configured to store compressed air and provide air to the plurality of inflatable bags 1004, e.g., via an air hose system 1304. As described in greater detail below, while a single air tank is shown in FIG. 13, in some implementations, multiple air tanks may be used.

In order to control the air pressure of the plurality of inflatable bags 1004, one or more pressure regulators such as, e.g., pressure regulators 1306 and 1308 may be used to connect the air tank 1302 to the air hose system 1304 to deliver pressurized air to the plurality of inflatable bags 1004. Each of the one or more pressure regulators 1306 and 1308 may generally function to modulate the flow of air from the air tank 1302 to a respective subset of the plurality of inflatable bags 1004, e.g., by opening and shutting a valve or the like. By modulating the flow of air from the air tank 1302, the pressure regulators 1306 and 1308 may regulate downstream pressure, thereby regulating the air pressure of the plurality of inflatable bags 1004.

The pressure regulators 1306 and 1308 may take various forms, such as high-flow, low-pressure regulators, among other possible pressure regulators. Further, in line with the discussion above, the plurality of inflatable bags 1004 may be designed to accommodate low levels of pressure, e.g., to reduce the likelihood of damaging the wing 1002 during the wing bend test. As such, the pressure regulators 1306 and 1308 may each be configured to regulate low levels of downstream pressure, e.g., within a range of around 0.5-5.0 PSI and with a tolerance of +/−0.1 PSI. However, the pressure regulators 1306 and 1308 may be configured to regulate other levels of downstream pressure, and may operate within other tolerance levels as well.

Further, while FIG. 13 includes two pressure regulators, in practice, other numbers of pressure regulators may be used, which may allow for more flexibility in controlling the air pressure of the plurality of inflatable bags 1004. For instance, a single pressure regulator may be utilized to control the air pressure of the entire plurality of inflatable bags 1004. As another example, a respective pressure regulator may be utilized to control the air pressure of each inflatable bag of the plurality of inflatable bags 1004, allowing for air pressure to be controlled on an inflatable bag level. Other examples may also exist. Utilizing multiple pressure regulators may be particularly useful in implementations where different inflatable bags are configured to apply different amounts of force to the underside of the wing 1002.

In order to help avoid over-pressurization of the plurality of inflatable bags 1004, one or more pressure relief valves may be coupled to the plurality of inflatable bags 1004. A representative pressure relief valve 1310 is labeled in FIG. 13. For instance, each of the plurality of inflatable bags 1004 may have a corresponding pressure relief valve, which may either be directly coupled to the inflatable bag or positioned along the air hose system 1304 in between (i) the pressure regulators 1306 and 1308 and (ii) the inflatable bag 1004. Each of the plurality of pressure relief valves may function to release (e.g., vent) air from the corresponding inflatable bag in order to prevent the air pressure of the inflatable bag from surpassing a threshold, e.g., to avoid applying an undue amount of upward force to the wing 1002 and/or to avoid damaging the inflatable bag.

The example air-based pressure control system 1300 also includes first and second pumps 1312 and 1314, each of which may be utilized to inflate a respective subset of the plurality of inflatable bags 1004 with air. Further, while two pumps are shown corresponding to respective subsets of inflatable bags, in some implementations, more or fewer pumps may be utilized, such as (i) a single pump for inflating the entirety of the plurality of inflatable bags 1004 or (ii) a respective pump for inflating each inflatable bag of the plurality of inflatable bags 1004, among other possibilities. In some implementations, the example air-based pressure control system 1300 may be utilized to separately control various subsets of the plurality of inflatable bags 1004, e.g., such that inflatable bags that are to apply similar levels of upward force to the underside of the wing 1002 are controlled together. As one example, one subset may include the inflatable bags that are to one side of the wing 1002 (e.g., a port side of the wing 1002) and a second subset may include the inflatable bags that are on the opposite side of the wing 1002 (e.g., a starboard side of the wing 1002). According to this example, the example air-based pressure control system 1300 may be utilized to separately control the distributed upward force applied to each side of the wing 1002. As another example, one subset may include symmetrically-positioned inflatable bags that are at/near the distal ends of the wing 1002, another subset may include symmetrically-positioned inflatable bags that are at/near the root of the wing 1002, and so forth. According to this example, the example air-based pressure control system 1300 may be utilized to apply a symmetrically-distributed upward force to the wing 1002, e.g., by controlling each symmetrical pair of inflatable bags together. Various other examples also exist. In implementations where the example air-based pressure control system 1300 is utilized to separately control different subsets of inflatable bags, a respective set of air tank(s), pressure regulator(s), pressure relief valve(s), and pump(s) may be utilized to control each subset.

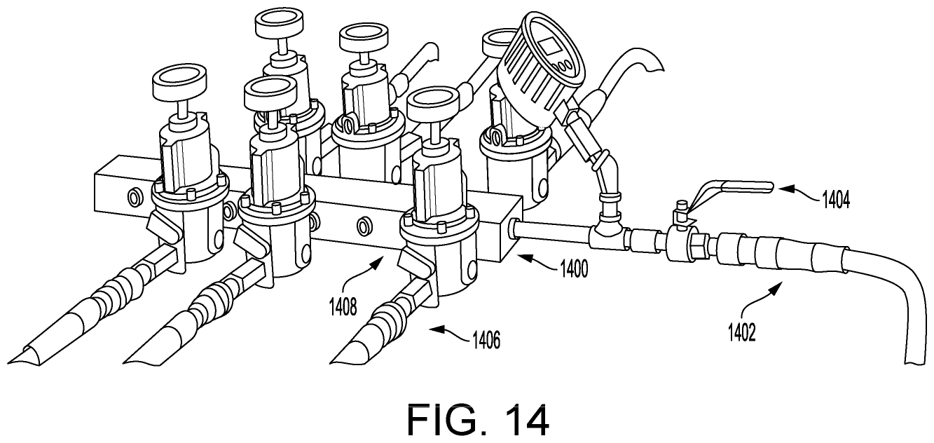

FIG. 14 shows an air manifold 1400 that may be utilized to implement the air-based pressure control system 1300 in line with the present disclosure.

The air manifold 1400 includes an inlet 1402 for receiving air from an air tank (e.g., the air tank 1302). The air manifold 1400 also includes a valve 1404 for controlling the air flow from the air tank to the air manifold 1400.

The air manifold 1400 also includes a plurality of outlets, of which a representative outlet 1406 is labeled. Each of the plurality of outlets may be connected to a respective hose that is also connected to a respective inflatable bag of the plurality of inflatable bags 1004. The air manifold 1400 also includes a plurality of gate valves, of which a respective gate valve 1408 is labeled. In some implementations, each of the plurality of gate valves may comprise a pressure regulator similar to the pressure regulators 1306 and 1308 described above, although the plurality of gate valves may take other forms as well. The plurality of gate valves may be utilized to control the pressure of a corresponding inflatable bag, e.g., by controlling the airflow from the air manifold 1400 to the corresponding inflatable bag.

The air manifold 1400 shown in FIG. 14 is just one example manner in which the example air-based pressure control system 1300 may be implemented, and it should be understood that the air-based pressure control system 1300 may be implemented in various other ways as well, including by adding additional components or removing components, among other things.

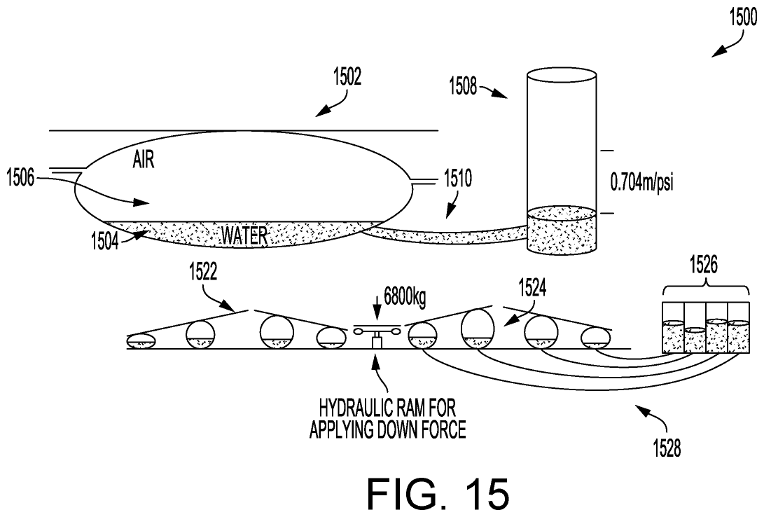

As another possibility, the pressure of the inflatable bags may be controlled via a liquid-based pressure control technique. FIG. 15 shows an example liquid-based pressure control system 1500.

As shown, the example liquid-based pressure control system 1500 includes an inflatable bag 1502, which may be one of the plurality of inflatable bags 1004. A first portion 1504 of the inflatable bag 1502 has been filled with water and a second portion 1506 of the inflatable bag 1502 has been filled with air. The water and air may be added to the inflatable bag 1502 in various ways. For instance, the inflatable bag 1502 may include an opening for adding water to the inflatable bag 1502, and air may be added in line with the description above with respect to FIGS. 13 and 14.

In one example, as shown in FIG. 15, the inflatable bag 1502 is connected to a water column 1508 via a water hose 1510 that is positioned below the water level of the first portion 1504. Once the inflatable bag 1502 is connected to the water column 1508 via the water hose 1510, the inflatable bag's pressure can be controlled and measured by manipulating the height of the water column 1508, e.g., based on hydrostatic pressure principles. The pressure of the water in the liquid-based pressure control system 1500 may be defined by the hydrostatic pressure formula shown below:

$$P = ρ g h$$

In this formula, the variable “P” refers to the pressure of the water in the liquid-based pressure control system 1500, the variable “p” (rho) refers to the density of water, the variable “g” refers to the gravitational constant, and the variable “h” refers to the height of the water. Given that the values for the variables “p” and “g” are constant, the pressure of the water in the liquid-based pressure control system 1500 (including the pressure of the water in the first portion 1504 of the inflatable bag 1502) may be controlled by changing the height of the water in the water column 1508.

The change in water pressure in the first portion 1504 of the inflatable bag 1502 may result in a corresponding change in the air pressure of the second portion 1506 of the inflatable bag 1502, e.g., according to Boyle's law. The relationship between the water pressure and the air pressure within the inflatable bag 1502 may be represented by the formula shown below:

$${P}_{water} {V}_{water} = {P}_{a i r} {V}_{a i r}$$

Accordingly, when the pressure of the water in the inflatable bag 1502 increases (e.g., based on additional water being added to the water column 1508), the pressure of the air in the inflatable bag 1502 must also increase (i.e., because the volume of the air is constant). Using this technique provides known, predictable quantities: in an example, each meter of water added to the water column 1508 increases the air pressure within the inflatable bag 1502 by 1.42 PSI. As may be appreciated, using this technique may allow for a relatively high level of precision and accuracy in controlling the air pressure of the inflatable bag 1502.

FIG. 15 also includes an illustration of a wing 1522, which may be similar to the wing 1002 of FIG. 10, as well as a plurality of inflatable bags 1524, which may be similar to the plurality of inflatable bags 1004. As shown, the right half of the plurality of inflatable bags 1524 is connected to a corresponding plurality of water columns 1526 via respective water hoses 1528. The left half of the plurality of inflatable bags 1524 may also be connected to a corresponding plurality of water columns (not shown) via respective water hoses (not shown). FIG. 15 shows how the example liquid-based pressure control system 1500 may be implemented at scale to control the air pressure of each of the plurality of inflatable bags 1524 to perform a wing bend test.

While FIG. 15 shows a single water column being used for a corresponding single inflatable bag, in some implementations, it may be possible for multiple inflatable bags to connect to a single water column. In such implementations, adding water to the single water column may result in simultaneous pressure control for each of the multiple inflatable bags connected to the single water column. Similar to the air-based pressure control system 1300, the liquid-based pressure control system 1500 may also be utilized to separately control different subsets of inflatable bags, and a respective water column may be utilized to control the pressure of each subset of inflatable bags. Various other examples may also exist.

The example liquid-based pressure control system 1500 may take other forms and be used in other ways as well. For instance, while the liquid-based pressure control system 1500 has been described as using water, other liquids may also be used.

Further, as shown, in some implementations a hydraulic ram or some other actuator may be utilized to apply a down force to the wing 1522 in order to simulate the weight of the vehicle that the wing 1522 is configured to attach to. As shown in FIG. 15, the weight of the vehicle may be approximately 6800 kg, although it should be understood that other weights could be possible as well. Further, while this hydraulic ram is shown in the context of FIG. 15, it should be understood that a hydraulic ram or other actuator may be used in any implementation of the disclosed approach for applying a down force to simulate the weight of a vehicle.

Further, in at least some implementations, the liquid-based pressure control system 1500 may be preferable to air-based pressure control systems. For instance, air-based pressure control systems may be limited to 0.02 PSI increments, which may result in up to 20% fluctuations in pressure variation, given that the plurality of inflatable bags 1004 are designed to accommodate low levels of pressure. Further, the liquid-based pressure control system 1500 may enable quicker pressure settling and more controllable adjustments than the imprecise gate valves and inherent compressibility issues of traditional air manifolds. However, it should be noted that both the air-based pressure control system 1300 and the liquid-based pressure control system 1500 correspond to viable systems for controlling the pressure of the plurality of inflatable bags 1004.

The disclosed pressure control systems may be utilized to control the pressure of inflatable bags in various ways. As one possibility, the disclosed pressure control systems may be manually operated in order to control the pressure of inflatable bags. For instance, the various components of the example air-based pressure control system 1300 may be manually adjusted and/or operated by an individual tasked with performing wing bend tests, such as (i) the air tank 1302, (ii) the air hose system 1304, (iii) the pressure regulators 1306 and 1308, (iv) the pressure relief valve 1310, and (v) the pumps 1312 and 1314. Similarly, the various components of the example liquid-based pressure control system 1500 may also be manually adjusted and/or operated by an individual tasked with performing wing bend tests, e.g., by manually adjusting the water level within one or more water columns.

As another possibility, the disclosed pressure control systems may be controlled via a computing system in order to control the pressure of inflatable bags. In some implementations, the computing system may be configured to control the pressure of the inflatable bags based on receiving input from a user of the computing system. For instance, an individual tasked with performing wing bend tests may input commands (e.g., via an interface of a computing device communicatively connected to the computing system) for performing one or more adjustments (e.g., adjusting the water level of a water column, engaging or disengaging a pressure relief valve, etc.), and the computing system may cause the commands to be executed in order to control the pressure of the inflatable bags. In other implementations, the computing system may be configured to automatically control the pressure of the inflatable bags in order to maintain appropriate pressure levels within the inflatable bags. For instance, the computing system may be configured to monitor various force and pressure measurements (e.g., captured by one or more sensors), and based on a determination that one or more inflatable bags are outside of an expected pressure level, the computing system may automatically adjust the pressure of the one or more inflatable bags in order to bring them into an appropriate pressure level.

Various other possibilities exist, including the possibility that some features of the disclosed pressure control systems may be manually operated while other features of the disclosed pressure control systems may be controlled via a computing system, either based on user input or automatically.

Regardless of which pressure control system is used to control the air pressure of the plurality of inflatable bags 1004, the disclosed approach may involve adjusting the air pressure slowly and incrementally to ensure wing safety.

The pressure of the plurality of inflatable bags 1202 may be controlled using other techniques as well.

In addition to controlling the upward force applied to the wing 1200 by the plurality of inflatable bags 1202 through pressure control, the disclosed approach also allows for the upward force to be controlled through design choices for the plurality of inflatable bags 1202. For instance, smaller inflatable bags may apply a smaller amount of upward force, perhaps over a smaller surface area, to the wing 1200 compared to larger inflatable bags (e.g., assuming a consistent internal pressure). By changing the dimensions (e.g., the size, shape, and/or distribution) of the plurality of inflatable bags 1202, it may be possible to simulate different load distributions for the wing 1200. For instance, depending on the geometry of the wing 1200, the wing 1200 may experience greater levels of force at the root (e.g., proximate end) than at the tip (e.g., distal end) during operation, creating an elliptical load distribution. The specifics of this elliptical load distribution may vary from one wing model to another, and some wings may have other types of load distributions other than elliptical load distributions. By controlling the upward force applied by the plurality of inflatable bags 1202, the disclosed approach allows for load distributions experienced by the wing 1200 during operation to be closely approximated during wing bend tests, along with other load distributions, as described in greater detail below.

Further, using differently sized and/or shaped inflatable bags may also be used to prevent localized damage, e.g., by placing larger inflatable bags underneath the more delicate portions of the wing 1200, such as the ribs of the wing 1200 that connect to spars, among other possible relatively delicate portions of the wing 1200.

The amount of upward force applied to the wing 1200 by the plurality of inflatable bags 1202 may be monitored during the wing bend test (i) to ensure that the wing 1200 is being subjected to appropriate levels of force according to the criteria of the wing bend test, and (ii) to ensure that the wing 1200 is not damaged during the wing bend test, e.g., by being subjected to excessive amounts of force. The amount of upward force applied to the wing 1200 by the plurality of inflatable bags 1202 may be measured in various ways.

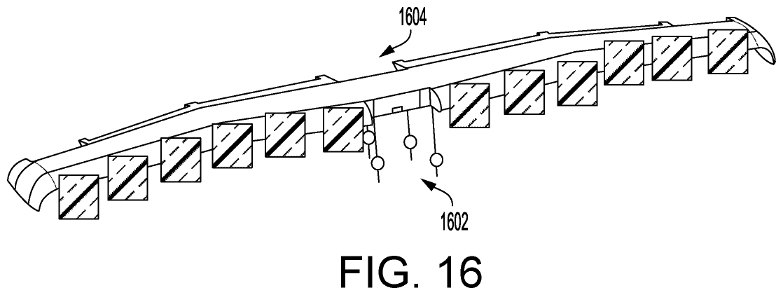

As one possibility, one or more load cells may be utilized to measure the upward force applied to the wing 1200 by the plurality of inflatable bags 1202. Turning now to FIG. 16, a plurality of load cells 1602 are shown, along with the wing 1002 and the plurality of inflatable bags 1004 as shown in FIG. 10. The plurality of load cells 1602 are coupled to a center portion 1604 of the wing 1002 and anchored to the ground. Each of the plurality of load cells 1602 may take the form of a transducer and may function to convert force into an electrical signal which may be read to measure the upward force applied to the wing 1002 by the plurality of inflatable bags 1004. Each of the plurality of load cells 1602 may be rated for a high maximum load, such as 2 tons, although other maximum loads are possible as well.

As another possibility, one or more load pins may be utilized to couple the wing 1002 to a test fixture (e.g., a rig), and measure the vertical reaction force from the test fixture corresponding to the upward force applied to the wing 1002 by the plurality of inflatable bags 1004 at the respective locations of the one or more load pins. In some implementations, the one or more load pins may be used in addition to or instead of one or more structural pins that would otherwise be used to mount the wing 1002 to the test fixture (when detached from the vehicle) or to the vehicle (when installed on the vehicle).

FIG. 17 shows an example wing 1700, where a center portion 1702 of the example wing 1700 is configured to connect to a rig 1704. As shown, the center portion 1702 is connected to the rig 1704 via a load pin 1706. While only a single load pin is shown, it should be understood that multiple load pins may be used to couple the center portion 1702 of the example wing 1700 to the rig 1704.

As shown in FIG. 17, a fiber optical strain sensor (FOSS) 1708 is also shown, which may be extended along the length of the example wing 1700. The FOSS 1708 may function to measure the strain of the example wing 1700 by detecting how light behavior changes within the FOSS 1708 in response to the strain of the example wing 1700. While the FOSS 1708 is described within the context of an example where load pins are utilized for force measurements, it should be understood that optical strain sensors—among other types of strain sensors—may be utilized alone and/or in other implementations as well.

As yet another possibility, a respective scale may be positioned underneath one or more of the plurality of inflatable bags 1004 to measure the amount of downward force being applied to the respective scale by the inflatable bag. As the downward force being applied to the respective scale by the inflatable bag is equal and opposite to the upward force being applied to the wing 1002 by the inflatable bag, measuring the downward force may serve as a proxy for measuring the upward force.

The amount of upward force applied to the wing 1002 by the plurality of inflatable bags 1004 may be measured in other ways as well.

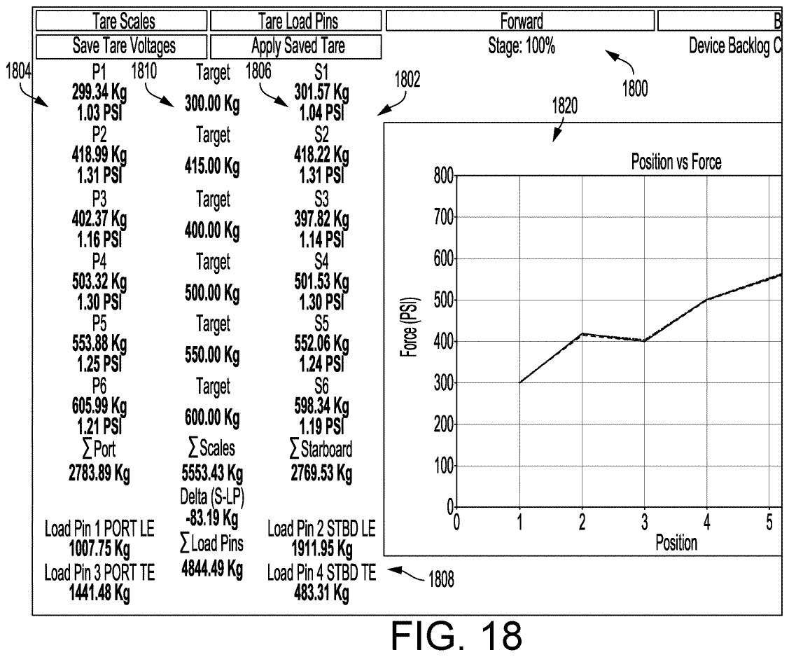

Turning now to FIG. 18, an example graphical user interface (GUI) 1800 is shown, which may be presented by a computing device (e.g., a laptop, computer, tablet, phone, or some other computing device) that is configured to run a software application for viewing measurements and possibly controlling various components of an apparatus for performing wing bend tests according to the disclosed approach. In some implementations, the computing device may be communicatively connected to the computing system described above for controlling the air pressure of the inflatable bags, and an individual tasked with performing wing bend tests may utilize the computing device in order to make adjustments to the air pressure of one or more inflatable bags in order to keep the upward forces applied to the underside of a wing within acceptable levels.

As shown, the example GUI 1800 includes a first region 1802 where measurement readings for the wing bend test may be presented. The first region 1802 includes a first column 1804 that includes force and pressure measurements for each of a first subset of the plurality of inflatable bags 1004, which may be positioned on a port side of the wing 1002. The first subset of the plurality of inflatable bags 1004 are shown as port-side inflatable bags P1-P6. As shown, the first column 1804 includes respective force and pressure measurements for each of the port-side inflatable bags P1-P6 as well as a total port-side force applied to the wing 1002 by the port-side inflatable bags P1-P6.

The first region 1802 also includes a second column 1806 that includes force and pressure measurements for each of a second subset of the plurality of inflatable bags 1004, which may be positioned on a starboard side of the wing 1002. The second subset of the plurality of inflatable bags 1004 are shown as starboard-side inflatable bags S1-S6. As shown, the second column 1806 includes respective force and pressure measurements for each of the starboard-side inflatable bags S1-S6 as well as a total starboard-side force applied to the wing 1002 by the starboard-side inflatable bags S1-S6.

The first region 1802 also includes a set of load pin force measurements 1808. As shown, the set of load pin force measurements 1808 includes a respective force measurement for each of four load pins, two positioned on the port side of the wing 1002 and two positioned on the starboard side of the wing 1002. However, the first region 1802 may include more or fewer load pin force measurements, depending on how many load pins are utilized in the wing bend test.

In some implementations, it may be desirable to have symmetrical forces to either side of the wing 1002. Accordingly, target forces may be set for pairs of port and starboard inflatable bags. For instance, a first target force may be set for the P1 and S1 pair of inflatable bags, a second target force may be set for the P2 and S2 pair of inflatable bags, and so forth. As shown, the first region 1802 includes a third column 1810 for presenting the target forces for pairs of port and starboard inflatable bags. The user may set the target forces in various ways, e.g., by providing input to input fields included in the third column 1810 or elsewhere in the example GUI 1800, among other ways of setting the target forces.

While the third column 1810 is shown including target forces for pairs of port and starboard inflatable bags, it should be appreciated that the first region 1802 may present target forces in other ways as well. For instance, in implementations where the forces applied to the wing 1002 are not desired to be symmetrical, the first region 1802 may include a presentation of a respective target force for each of the plurality of inflatable bags 1004. Various other examples are possible as well.

The third column 1810 also includes measurements for (i) the total force measured by a plurality of scales (e.g., in implementations where a plurality of scales are used to measure the force applied by the plurality of inflatable bags), (ii) the delta of between the force applied to the port side of the wing 1002 and the force applied to the starboard side of the wing 1002, and (iii) the total force measured by the set of load pins. As may be appreciated, the first region 1802 of the GUI 1800 may include other measurements as well, such as water levels, strain levels (e.g., based on measurements from a FOSS or some other strain sensor), among other possible measurements.

The example GUI 1800 also includes a second region 1820, where a graph may be presented plotting the force applied to various positions along the length of the wing 1002. Each position shown on the graph may correspond to a respective pair of port and starboard inflatable bags. For instance, the position “1” may correspond to the P1 and S1 inflatable bags, the position “2” may correspond to the P2 and S2 inflatable bags, and so forth. The graph may include a first line for the forces at positions along the port side of the wing 1002 and a second line for the forces at positions along the starboard side of the wing 1002. The graph shows the first and second lines overlapping, which may be because in the example shown in FIG. 18, the forces applied to the wing 1002 are symmetrical, such that the same (or substantially similar) amount of force is applied by each port-starboard pair of inflatable bags. However, in implementations where the force is not symmetric, the first and second lines may be shown more distinctly.

The measurements shown in the first and second regions 1802 and 1820 of the example GUI 1800 may be updated in real time as wing bend tests are performed. This may allow a user viewing the example GUI 1800 to monitor the progression of the wing bend test and ensure that the forces and pressures are at expected levels. And if the user notices any discrepancies, the user may be able to respond appropriately in order to bring the measurements back to expected levels, e.g., by increasing or reducing the pressure of one or more of the plurality of inflatable bags 1004, among other examples. As one example, if an inflatable bag fails (e.g., due to a rupture or some other cause for failure), then the user may respond by causing the other inflatable bags to begin to deflate, to reduce the risk of any isolated damage to be incurred by the wing. Various other examples may also exist. Further, in line with the discussion above, a computing system may be utilized to control the pressure of the plurality of inflatable bags 1004, either based on user input or possibly automatically, e.g., based on the measurements shown in the example GUI 1800, among other possible sensor readings and the like.

The disclosed approach may be utilized for performing various types of wing bend tests. One type of wing bend test that may be performed via the disclosed approach may include a static strain wing bend test. Static strain tests may involve assessing a wing's structural integrity under sustained loads. For performing static strain tests, each of the plurality of inflatable bags 1004 may be configured to apply a consistent amount of upward force to the underside of the wing 1002. In some implementations, this may involve consistently applying an evenly distributed force to the wing 1002 (e.g., each inflatable bag applies the same amount of force) for a period of time, while in other implementations, this may involve consistently applying a non-evenly distributed force to the wing 1002 for a period of time (e.g., different inflatable bags may apply different amounts of force, such as for simulating an elliptical load distribution of the wing 1002). In line with the discussion above, force, pressure, strain, and possibly other measurements may be taken during the static strain wing bend test, and adjustments may be made to ensure the consistent application of force to the underside of the wing 1002 according to the static strain test being performed on the wing 1002.

In some implementations, static strain tests may be performed in order to simulate load distributions that a wing is expected to experience during regular operation. Accordingly, in line with the discussion above, the distributed force applied to the wing 1002 by the plurality of inflatable bags 1004 may be set to simulate the load distribution that the wing 1002 is expected to experience during regular operation. In other implementations, static strain tests may be performed in order to simulate load distributions other than what a wing is expected to experience during regular operation. Accordingly, the distributed force applied to the wing 1002 by the plurality of inflatable bags 1004 may be set to simulate load distributions not expected to be experienced by the wing 1002 during regular operation. For instance, extreme load distributions (e.g., heavier than expected load distributions) may be simulated in order to test the structural integrity of the wing 1002. Static strain tests may be performed utilizing the disclosed approach in order to simulate other load distributions as well.

Another type of wing bend test that may be performed via the disclosed approach may include a dynamic fatigue test. Dynamic fatigue tests may involve assessing a wing's structural integrity under varying loads that are applied cyclically over a period of time. For performing dynamic fatigue tests, each of the plurality of inflatable bags 1004 may be configured to apply a variable amount of upward force to the underside of the wing 1002, wherein the amount of upward force is increased and decreased according to a cyclical pattern. In some implementations, this may involve applying a variable, yet evenly distributed force to the wing 1002 (e.g., each inflatable bag may apply the same variable amount of force) in a cyclical manner for a period of time. In other implementations, this may involve applying a variable and non-evenly distributed force to the wing 1002 (e.g., different inflatable bags may apply different variable amounts of force) in a cyclical manner for a period of time. It should be noted that at least because the disclosed approach does not involve the use of metal attachment points (e.g., as used in whiffle tree configurations), the disclosed approach is better able to perform dynamic fatigue tests, as the metal attachment points of current approaches are prone to wear out and potentially break during dynamic fatigue testing. Further, in some implementations, the varying loads applied during dynamic fatigue tests may include loads that a wing is likely to experience during regular operations, while in other implementations, the varying loads applied during dynamic fatigue tests may include loads other than what a wing is expected to experience during regular operation. For instance, extreme loads (e.g., heavier than expected loads) may be variably applied to the wing 1002 in order to test the structural integrity of the wing 1002. Dynamic fatigue tests may be performed utilizing the disclosed approach in order to apply other varying loads as well.

Further, the disclosed approach may also be used to test various bending modes of the wing 1002. One bending mode that may be tested according to the disclosed approach may be an out-of-plane bending mode, where vertical forces are applied to the underside of the wing 1002, causing the wing 1002 to bend upward (e.g., because the middle portion of the wing 1002 is either anchored to a test fixture (e.g., a rig) or installed on a vehicle).

Another bending mode that may be tested according to the disclosed approach may be a torsion bending mode, where the wing 1002 twists along its length. This may be accomplished in various ways. As one possibility, multiple rows of inflatable bags may be positioned underneath the wing 1002. For instance, a first row of inflatable bags may be positioned along the leading edge of the wing 1002, and a second row of inflatable bags may be positioned along the trailing edge of the wing 1002. When the first row of inflatable bags applies a higher level of force to the wing 1002 than the second row of inflatable bags, the wing 1002 may twist so that the wing's leading edge rotates up relative to the wing's trailing edge. Similarly, when the second row of inflatable bags applies a higher level of force to the wing 1002 than the first row of inflatable bags, the wing 1002 may twist so that the wing's leading edge rotates down relative to the wing's trailing edge.

By implementing multiple rows of inflatable bags, torsion modes of bending may be tested in addition to or instead of out-of-plane modes of bending, allowing for more variability in wing bend tests in order to better simulate the aerodynamic lift forces that may be experienced during operation. The disclosed approach may cause the wing 1002 to bend in a torsion bending mode in other ways as well.

The disclosed approach may be utilized to test other bending modes of the wing 1002 as well. Further, the disclosed approach may be utilized to perform other types of wing bend tests as well.

In some implementations, the disclosed approach may be utilized to test wings having different aerodynamic load profiles. This may involve adjusting the plurality of inflatable bags 1004 in various ways (e.g., by repositioning inflatable bags, using inflatable bags of various shapes and/or sizes, pressurizing inflatable bags to various levels, etc.) in order to apply highly configurable distributions of force to wings. For instance, the plurality of inflatable bags 1004 may be configured according to a first load profile such that the plurality of inflatable bags 1004 applies a first distribution of force to the underside of a first wing (e.g., including a first set of forces at various positions of the first wing), and may also be configured according to a second, different load profile such that the plurality of inflatable bags 1004 applies a second, different distribution of force to the underside of a second, different wing, e.g., including a second, different set of forces at the same or possibly different positions of the second wing). Various other examples may also exist.

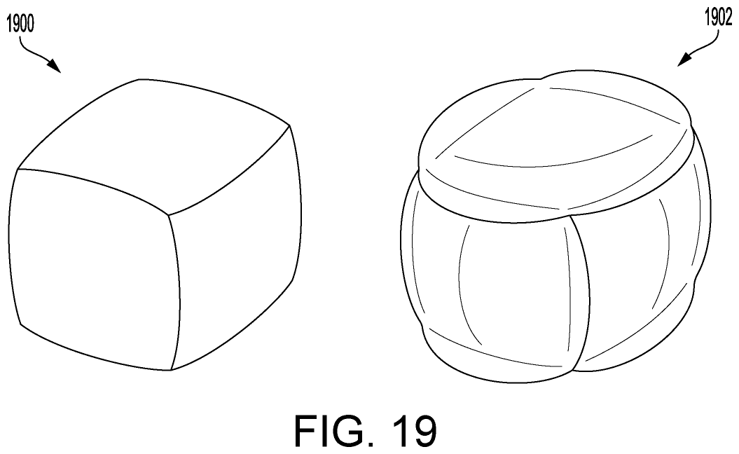

Turning now to FIG. 19, an example illustration of an inflatable bag 1900 is shown, as well as a deformed inflatable bag 1902. One potential limitation of using inflatable bags to perform wing bend tests is that when subjected to load and/or partial deflation, an inflatable bag may partially deform, which may lead to uncertainty in wing bend tests, as it may be difficult to accurately measure the amount of force applied by the deformed bag on a wing. For instance, bag deformation may cause irregularity in the contact area between the bag and the wing, which consequentially causes a non-linear application of force on the wing. This makes it difficult to accurately quantify the applied force to the wing, thereby compromising the precision of the wing bend test and potentially risking damage to the relatively delicate wing structure, e.g., if excessive force is applied due to bag deformation.

The deformed inflatable bag 1902 may deform into various shapes. As shown in FIG. 19, the deformed inflatable bag 1902 has partially caved in on the sides, resulting in a “muffin top” shape on the top surface of the deformed inflatable bag 1902. However, it may be possible for inflatable bags to deform in other ways as well.

Bag deformation may be managed in any of various ways. As one possibility, an inflatable bag may be equipped with a tensioning element (e.g., a rigidizing strap or belt) around a top perimeter of the inflatable bag close to the top of the inflatable bag. This may prevent outward bulging and may allow the inflatable bag to maintain a constant contact surface for applying force to the wing. While deformation may occur under the tensioning element, the contact surface of the inflatable bag is not compromised.

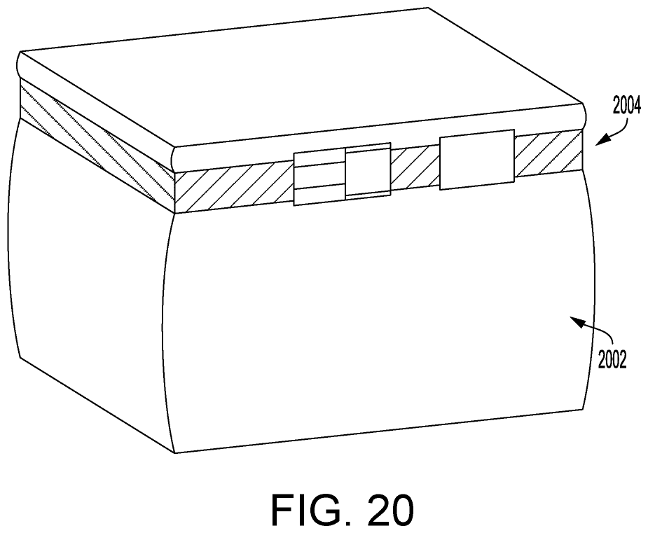

FIG. 20 shows an example inflatable bag 2002 that includes a tensioning element 2004 around the top perimeter of the inflatable bag 2002. The tensioning element 2004 may be equipped on the inflatable bag 2002 in various ways. In some implementations, the tensioning element 2004 may be permanently integrated as part of the inflatable bag's surface, e.g., by stitching the tensioning element to the inflatable bag 2002 around the top perimeter of the inflatable bag 2002. In other implementations, the tensioning element 2004 may be temporarily added to the inflatable bag 2002, e.g., by passing the tensioning element 2004 through a plurality of loops around the top perimeter of the inflatable bag 2002 (e.g., similar to how a belt may be passed through a plurality of belt loops). Other implementations are also possible. Further, the tensioning element 2004 may take various forms and/or various materials. The width of the tensioning element 2004 may be determined based on the dimensions of the inflatable bag 2002, so as to enable the inflatable bag 2002 to maintain a constant contact surface during operation.

As another possibility, a cap element may be placed over the top of an inflatable bag. This external containment prevents the uncontrolled outward deformation of the inflatable bag's upper surface, while also providing a consistent and predictable contact surface with the wing. Similar to the inflatable bag equipped with a tensioning element, while an inflatable bag equipped with a cap element may still experience deformation under the cap element, the contact surface of the inflatable bag is not compromised. Further, in some implementations, the cap element may be equipped with a slip-resistant material, such as the slip-resistant material described above.

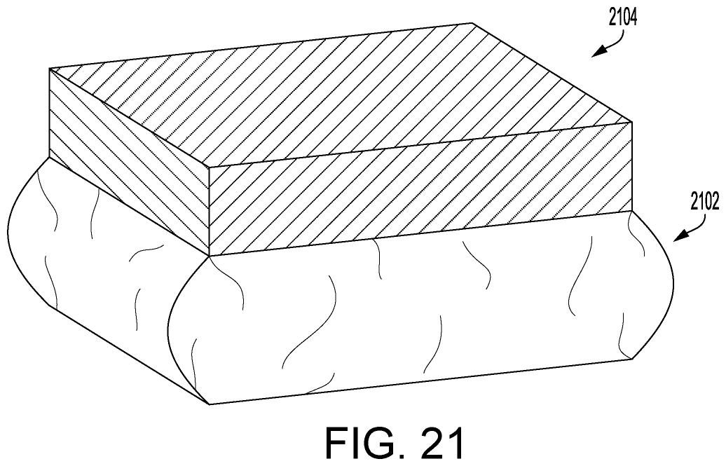

FIG. 21 shows an example inflatable bag 2102 that includes a cap element 2104 on the top surface of the inflatable bag 2102. Similar to the tensioning element 2004 of FIG. 20, the cap element 2104 may be permanently integrated as part of the inflatable bag's surface (e.g., by stitching the cap element 2104 to the top of the inflatable bag 2102, among other examples), or may be temporarily added to the inflatable bag 2102. Further, the cap element 2104 may take various forms, such as a metal or hard plastic case, among other possible forms.

As yet another possibility, an inflatable bag may be designed with a drop-stitched material, which may ensure that the bag's intended shape is maintained under pressure variations.

As yet another possibility, a scale may be positioned underneath an inflatable bag to measure the amount of downward force being applied to the scale by the inflatable bag. As the downward force being applied to the scale by the inflatable bag is equal and opposite to the upward force being applied to the wing by the inflatable bag, measuring the downward force may serve as a proxy for measuring the upward force.

In combination with positioning a scale underneath the inflatable bag, a substrate may also be positioned between the inflatable bag and the surface of the wing to ensure that the upward force applied to the wing by the inflatable bag is evenly distributed, despite any deformations of the inflatable bag. The substrate may take various forms. As one example, the substrate may comprise (i) a soft layer, such as Styrofoam™ or some other soft layer, and (ii) a rigid layer, such as plywood or some other hard layer. The soft layer may be configured to make contact with the wing, whereas the rigid layer may be positioned underneath the soft layer to provide structure and rigidity to the substrate.

The disclosure herein refers at times to an “apparatus” for performing wing bend tests according to the disclosed approach. This apparatus may generally refer to the various components described herein that are utilized to perform said tests. For instance, the apparatus may include any combination of the various components described with respect to FIGS. 10-21 and their respective descriptions.

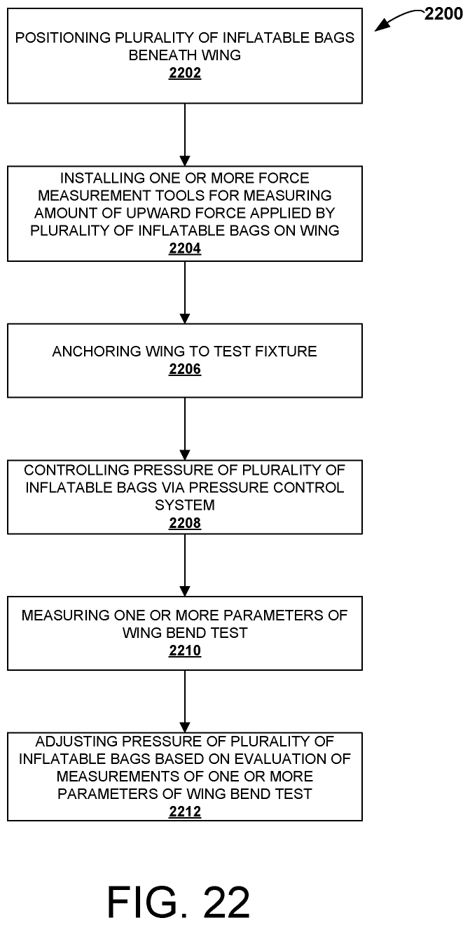

One possible example of functionality for performing a wing bend test in accordance with the disclosed approach will now be described with reference to functionality 2200 shown in the flow chart of FIG. 22. In practice, the functionality 2200 of FIG. 22 may be encoded in the form of program instructions that are executable by one or more processors of a computing system, in line with the discussion above. Further, in some implementations, the computing system may be configured to operate machinery for performing the functionality 2200, such as a robotic assembly or the like, among other possibilities. Further, it should be understood that the functionality 2200 of FIG. 22 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

At block 2202, the functionality 2200 may involve positioning a plurality of inflatable bags beneath a wing. In line with the discussion above, this may involve selecting positions for inflatable bags, for example, in order to simulate the load distribution profile of the wing. Further, in line with the discussion above, this may involve selecting inflatable bags of different sizes and shapes to be included in the plurality of selected inflatable bags, which may (i) reduce the risk of damaging the wing and (ii) allow for more precise simulation of the load distribution profile of the wing.

In some implementations, the plurality of inflatable bags may be positioned via a robotic arm or other mechanical hardware that is configured to position the plurality of inflatable wings. In other implementations, the plurality of inflatable bags may be positioned by a user tasked with preparing the wing bend test.

At block 2204, the example functionality 2200 may involve installing one or more measurement tools for measuring one or more parameters of the wing bend test.

As one possibility, this may involve installing one or more force measurement tools for measuring the amount of upward force applied by the plurality of inflatable bags on the wing. As one example, installing one or more force measurement tools may involve positioning a respective scale beneath each of the plurality of inflatable bags to directly measure the total vertical force exerted by the inflatable bag on the wing. In line with the discussion above, this may also involve positioning a respective substrate between each of the plurality of inflatable bags and the wing, such as a soft layer and a rigid layer—which may (i) reduce the risk of damaging the wing (e.g., due to the soft layer) and (ii) ensure a smooth and consistent contact area with the wing for applying the upward force. As another example, installing one or more force measurement tools may involve installing a set of load pins to connect the wing to a test fixture (e.g., a rig), e.g., replacing a set of structural pins otherwise used to connect the wing to the test fixture. As yet another example, installing one or more measurement tools may involve connecting a set of load cells to the wing, e.g., to measure the amount of upward force applied to the wing by the plurality of inflatable bags. Various other examples may also exist.

As another possibility, this may involve installing one or more strain measurement tools for measuring the strain along the length of the wing, such as a FOSS or some other strain measurement tool.

Various other possibilities may also exist.

At block 2206, the example functionality 2200 may involve anchoring the wing to a test fixture. The test fixture may take various forms, such as a rig, in line with the discussion above. Further, the wing may be anchored to the test fixture at various points, e.g., at a middle portion of the wing or at a proximate end of the wing, among other possibilities. Further, the wing may be anchored to the test fixture in various ways. As one possibility, the wing may be anchored to the test fixture using one or more load pins, although other possibilities may also exist.

At block 2208, the example functionality 2200 may involve controlling the pressure of the plurality of inflatable bags via a pressure control system. To begin, this may involve inflating the bags with fluid (e.g., air and possibly water or some other liquid). Once inflated, the example functionality 2200 may involve utilizing a pressure control system to control the pressure of the plurality of inflatable bags. As one possibility, the example functionality 2200 may involve utilizing an air-based pressure control system to control the pressure of the plurality of inflatable bags, as described above with respect to FIGS. 13 and 14. As another possibility, the example functionality 2200 may involve utilizing a liquid-based pressure control system to control the pressure of the plurality of inflatable bags, as described above with respect to FIG. 15. As yet another possibility, the example functionality 2200 may involve utilizing both an air-based pressure control system and a liquid-based pressure control system to control the pressure of the plurality of inflatable bags. Various other possibilities may also exist.

At block 2210, the example functionality 2200 may involve measuring one or more parameters of the wing bend test. In line with the discussion above, some parameters of the wing bend test may include (i) the upward force applied to the wing by the plurality of inflatable bags, (ii) the strain of the wing along the length of the wing, and (iii) deflections of the wing at various points, among other possible parameters. To measure the upward force applied to the wing by the plurality of inflatable bags, the example functionality 2200 at block 2210 may involve utilizing the one or more force measurement tools installed at block 2204 (e.g., a plurality of scales, a set of load pins, and/or a set of load cells, among other examples). To measure the strain along the length of the wing, the example functionality 2200 at block 2210 may involve utilizing the FOSS or other strain measurement tool installed at block 2204. Various other possibilities may also exist.

At block 2212, the example functionality 2200 may involve adjusting the pressure of the plurality of inflatable bags, e.g., based on an evaluation of the measurements of the parameters of the wing bend test described above with respect to block 2212. As one example, if a given inflatable bag is applying an excessively high amount of force, then the example functionality 2200 at block 2212 may involve decreasing the pressure of the given inflatable bag in order to reduce the amount of force being applied by the given inflatable bag. As another example, if a given inflatable bag deflates (e.g., due to a burst or some other failure), then the example functionality 2200 at block 2212 may involve decreasing the pressure of the rest of the plurality of inflatable bags, e.g., to safely abort the wing bend test while minimizing the damage done to the wing. Various other examples may also exist.

The example functionality 2200 may be carried out in various ways. In line with the discussion above, a computing system may be configured to operate, either automatically or based on user input, a robotic assembly or the like to carry out the example functionality 2200, e.g., via robotic arms or the like. In some implementations, workers may also utilize the disclosed approach to perform wing tests, e.g., using the example apparatus disclosed herein. The example functionality 2200 may be carried out in other ways as well.

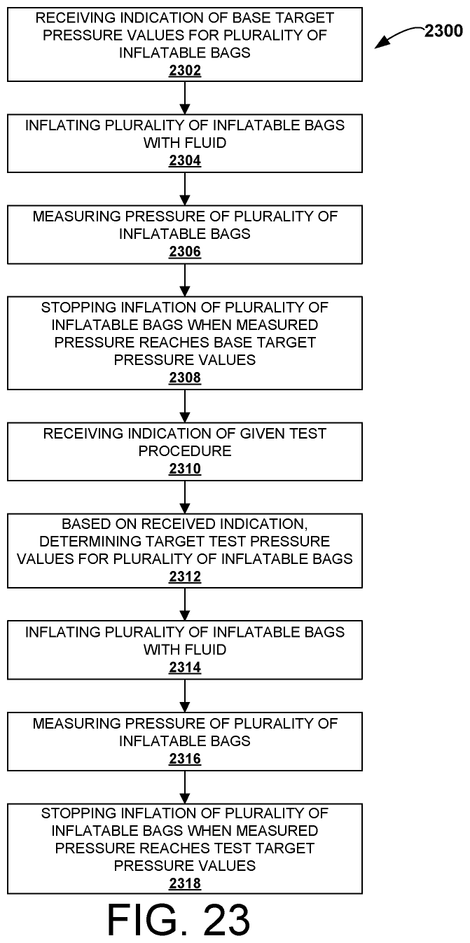

Another possible example of functionality for performing a wing bend test in accordance with the disclosed approach will now be described with reference to functionality 2300 shown in the flow chart of FIG. 23. In practice, the functionality 2300 of FIG. 23 may be encoded in the form of program instructions that are executable by one or more processors of a computing system, in line with the discussion above. Further, in some implementations, the computing system may be configured to operate machinery for performing the functionality 2300, such as a robotic assembly or the like, among other possibilities. Further, it should be understood that the functionality 2300 of FIG. 23 is merely described in this manner for the sake of clarity and explanation and that the example may be implemented in various other manners, including the possibility that functions may be added, removed, rearranged into different orders, combined into fewer blocks, and/or separated into additional blocks depending upon the particular example.

At block 2302, the functionality 2300 may involve the computing system receiving an indication of one or more base target pressure values for a plurality of inflatable bags positioned under a wing for performing a wing bend test. Each base target pressure value may represent a respective initial internal pressure for the plurality of inflatable bags prior to the start of the wing bend test. In some implementations, the base target pressure value may be the same for each inflatable bag of the plurality of inflatable bags, while in other implementations, the base target pressure values for the plurality of inflatable bags may differ, e.g., depending on bag placement, bag size, bag shape, wing geometry, etc.

The computing system may receive the indication of the base target pressure values in various ways. As one possibility, an individual tasked with performing a wing bend test may input the indication to an interface of a computing device, which may be communicatively connected to the computing system, e.g., via a communication path. The computing system may receive the indication of the base target pressure values in other ways as well.

At block 2304, the functionality 2300 may involve inflating the plurality of inflatable bags with fluid (e.g., air and possibly some water or some other liquid). To inflate the plurality of inflatable bags with air, the computing system may utilize one or more pumps, in line with the discussion above with respect to the example air-based pressure control system 1300. The computing system may also utilize other components of the air-based pressure control system 1300 to inflate the plurality of inflatable bags with air, among other possible components. To inflate the plurality of inflatable bags with water (or some other liquid), the computing system may utilize one or more water hoses, in line with the discussion above with respect to the example liquid-based pressure control system 1500. The computing system may also utilize other components of the liquid-based pressure control system 1500 to inflate the plurality of inflatable bags with water (or some other liquid), among other possible components.

At block 2306, the functionality 2300 may involve measuring the pressure of the plurality of inflatable bags, e.g., utilizing one or more sensors of a pressure control system, among other possible sensors or measurement tools. Examples of said pressure measurements are shown in the example GUI 1800, in line with the discussion above.

At block 2308, the functionality 2300 may involve stopping inflation of the plurality of inflatable bags when the measured pressure of the plurality of inflatable bags reaches the base target pressure values. This may be performed separately for each inflatable bag, such that the computing system stops the inflation of each respective inflatable bag when the respective inflatable bag reaches the base target pressure value corresponding to the respective inflatable bag. This may result in the computing system stopping the inflation of different inflatable bags at the same or different times, depending on factors such as the base target pressure value, size, and inflation rate of each inflatable bag, among other possible factors.

At block 2310, the functionality 2300 may involve receiving an indication of a given test procedure. The given test procedure may correspond to any of various types of wing bend tests, such as static strain wing bend tests, dynamic fatigue wing bend tests, wing bend tests for different bending modes, and so forth. Further, any given type of wing bend test may be modified to simulate different load distributions, e.g., which may be tailored to the geometry of the wing that is being tested. Accordingly, the indication of the given test procedure may include an indication of what type of wing bend test is to be performed, as well as what load distribution is to be applied during the wing bend test.

The computing system may receive the indication of the given test procedure in various ways. As one possibility, an individual tasked with performing a wing bend test may input the indication to an interface of a computing device, which may be communicatively connected to the computing system, e.g., via a communication path. The computing system may receive the indication of the given test procedure in other ways as well.

At block 2312, the functionality 2300 may involve, based on the received indication, determining test target pressure values for the plurality of inflatable bags. For instance, based on the load distribution that is to be simulated, the computing system may determine a respective test target pressure value for each inflatable bag of the plurality of inflatable bags, such that when each inflatable bag reaches its respective test target pressure value, the plurality of inflatable bags will simulate the load distribution. The computing system may accomplish this in various ways, e.g., based on an evaluation of the geometry of the wing to be tested, the information included in the received indication, the number, positioning, and sizes of the plurality of inflatable bags, and so forth.

At block 2314, the functionality 2300 may involve inflating the plurality of inflatable bags with fluid, which the computing system may accomplish in the manner described above with respect to block 2304.

At block 2316, the functionality 2300 may involve measuring the pressure of the plurality of inflatable bags, e.g., utilizing one or more sensors of a pressure control system, among other possible sensors or measurement tools. Examples of said pressure measurements are shown in the example GUI 1800, in line with the discussion above.

At block 2318, the functionality 2300 may involve stopping inflation of the plurality of inflatable bags when the measured pressure of the plurality of inflatable bags reaches the test target pressure values. This may be performed separately for each inflatable bag, such that the computing system stops the inflation of each respective inflatable bag when the respective inflatable bag reaches the test target pressure value corresponding to the respective inflatable bag. This may result in the computing system stopping the inflation of different inflatable bags at the same or different times, depending on factors such as the base target pressure value, size, and inflation rate of each inflatable bag, among other possible factors.

In line with the discussion above, static strain wing bend tests may involve the plurality of inflatable bags maintaining the test target pressure values for a given duration of time. Accordingly, the functionality 2300 may also involve the computing system determining a duration of time for the plurality of inflatable bags to maintain the test target pressure values, e.g., based on the indication of the given test procedure described above with respect to block 2310. Additionally, in line with the discussion above, dynamic strain wing bend tests may involve the plurality of inflatable bags being inflated to variable pressure levels over a period of time, where the pressure levels are increased and decreased according to a cyclical pattern. Accordingly, the functionality 2300 may also involve the computing system determining the variable pressure levels and timing information needed for the plurality of inflatable bags to perform a dynamic strain wing bend test. This may include the computing system determining, for each inflatable bag of the plurality of inflatable bags, a given test target pressure level for the inflatable bag at each point in time along a cyclical pattern. The functionality 2300 may be utilized in similar ways to perform other types of wing bend tests as well.

Further, in some implementations, the functionality 2300 may also involve deflating at least one of the plurality of inflatable bags. This may be performed at various times and for various reasons, such as (i) at the completion of a given wing bend test, (ii) when an inflatable bag is over-pressurized, and/or (iii) as part of a dynamic fatigue wing bend test, among other possibilities.

Further, some or all of the functionality 2300 may be repeated a number of times as part of a given wing bend test. For instance, the computing system may determine, based on the given test procedure received at block 2310, to repeat any of the operations of blocks 2312-2318, e.g., in order to perform the wing bend test corresponding to the given test procedure. Some or all of the functionality 2300 may be repeated at other times and for other reasons as well.

### VI. Example Computing Platform

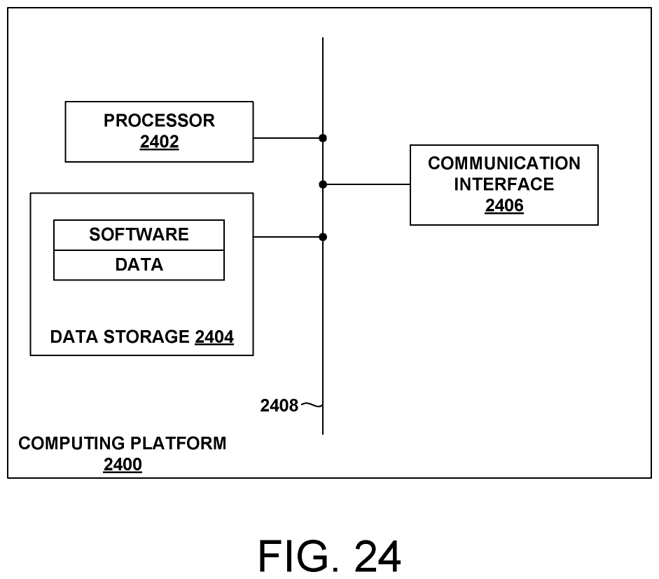

Turning now to FIG. 24, a simplified block diagram is provided to illustrate some structural components that may be included in an example computing platform 2400 that may be configured to carry out any of the various functions disclosed herein, including but not limited to any of the functions described above with reference to FIGS. 9-23. At a high level, the example computing platform 2400 may generally comprise any one or more computing systems that collectively include one or more processors 2402, data storage 2404, and one or more communication interfaces 2406, all of which may be communicatively linked by a communication link 2408 that may take the form of a system bus, a communication network such as a public, private, or hybrid cloud, or some other connection mechanism. Each of these components may take various forms.

The one or more processors 2402 may each comprise one or more processing components, such as general-purpose processors (e.g., a single- or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. In line with the discussion above, it should also be understood that the one or more processors 2402 could comprise processing components that are distributed across a plurality of physical computing systems connected via a network.

In turn, the data storage 2404 may comprise one or more non-transitory computer-readable storage mediums that are collectively configured to store (i) program instructions that are executable by one or more processors 2402 such that computing platform 2400 is configured to perform any of the various functions disclosed herein, and (ii) data that may be received, derived, or otherwise stored, for example, in one or more databases, file systems, repositories, or the like, by computing platform 2400, in connection with performing any of the various functions disclosed herein. In this respect, the one or more non-transitory computer-readable storage mediums of the data storage 2404 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 2404 may comprise computer-readable storage mediums that are distributed across a plurality of physical computing systems connected via a network.

The one or more communication interfaces 2406 may be configured to facilitate wireless and/or wired communication with other systems and/or devices, such as client devices (e.g., one or more client devices 2400 of FIG. 24). Additionally, in an implementation where the computing platform 2400 comprises a plurality of physical computing systems connected via a network, the one or more communication interfaces 2406 may be configured to facilitate wireless and/or wired communication between these physical computing systems (e.g., between computing and storage clusters in a cloud network). As such, the one or more communication interfaces 2406 may each take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

Although not shown, the computing platform 2400 may additionally include or have an interface for connecting to one or more user-interface components that facilitate user interaction with the computing platform 2400, such as a keyboard, a mouse, a trackpad, a display screen, a touch-sensitive interface, a stylus, a virtual-reality headset, and/or one or more speaker components, among other possibilities.

It should be understood that the computing platform 2400 is one example of a computing platform that may be used with the embodiments described herein. Numerous other arrangements are possible and contemplated herein. For instance, in other embodiments, the computing platform 2400 may include additional components not pictured and/or more or fewer of the pictured components.

### VII. Example Client Device

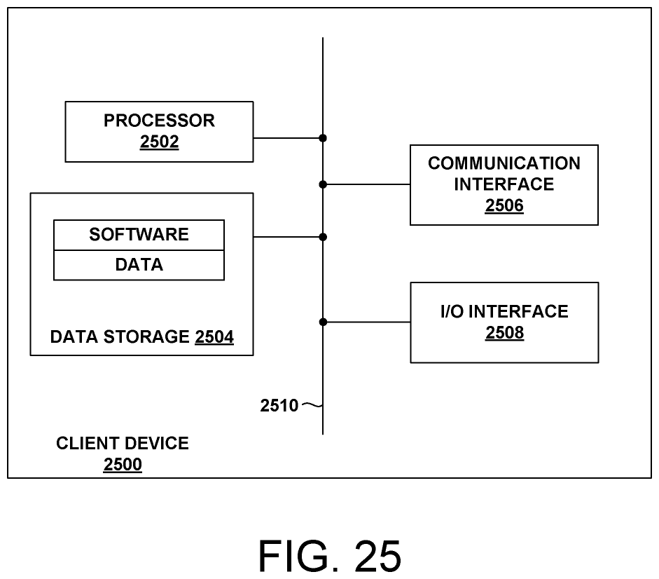

Turning next to FIG. 25, a simplified block diagram is provided to illustrate some structural components that may be included in an example client device 2500 that is configured to communicate with the computing platform 2400, such as a client device used by a worker tasked with performing wing bend tests. As shown in FIG. 25, the client device 2500 may include one or more processors 2502, data storage 2504, one or more communication interfaces 2506, and one or more user-interface components 2508, all of which may be communicatively linked by a communication link 2510 that may take the form of a system bus or some other connection mechanism. Each of these components may take various forms.

The one or more processors 2502 may comprise one or more processing components, such as general-purpose processors (e.g., a single- or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 2504 may comprise one or more non-transitory computer-readable storage mediums that are collectively configured to store (i) program instructions that are executable by the processor(s) 2502 such that the client device 2500 is configured to perform certain functions related to interacting with and accessing services provided by a computing platform, and (ii) data that may be received, derived, or otherwise stored, for example, in one or more databases, file systems, repositories, or the like, by the client device 2500, related to interacting with and accessing services provided by a computing platform. In this respect, the one or more non-transitory computer-readable storage mediums of the data storage 2504 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 2504 may take other forms and/or store data in other manners as well.

The one or more communication interfaces 2506 may be configured to facilitate wireless and/or wired communication with other computing devices. The communication interface(s) 2506 may take any of various forms, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

The client device 2500 may additionally include or have interfaces for one or more user-interface components 2508 that facilitate user interaction with the client device 2500, such as a keyboard, a mouse, a trackpad, a display screen, a touch-sensitive interface, a stylus, a virtual-reality headset, and/or one or more speaker components, among other possibilities.

It should be understood that the client device 2500 is one example of a client device that may be used to interact with an example computing platform as described herein. Numerous other arrangements are possible and contemplated herein. For instance, in other embodiments, the client device 2500 may include additional components not pictured and/or more or fewer of the pictured components.

### VIII. Conclusion

The above detailed description describes various features and functions of the disclosed craft and methods of operation with reference to the accompanying figures. While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method for performing a wing bend test on a vehicle wing, the method comprising:
positioning a plurality of inflatable bags underneath an underside of the wing, wherein each of the plurality of inflatable bags is configured to, when inflated, apply an upward force to the underside of the wing;
installing one or more measurement tools for measuring one or more parameters of the wing bend test, wherein at least one of the one or more parameters comprises an upward force applied by the plurality of inflatable bags on the wing;
for each of the plurality of inflatable bags, controlling a pressure of the inflatable bag via a pressure control system;
utilizing at least one of the one or more measurement tools, measuring the upward force applied by the plurality of inflatable bags on the wing;
based on an evaluation of the measured upward force applied by the plurality of inflatable bags on the wing, adjusting the pressure of at least one of the plurality of inflatable bags.

2. The method of claim 1, wherein the pressure control system comprises an air-based pressure control system including an air manifold and a plurality of gate valves, wherein each of the plurality of gate valves is configured to control an air pressure for a respective one of the plurality of inflatable bags.

3. The method of claim 1, wherein the pressure control system comprises a liquid-based pressure control system including a water column connected to the inflatable bag via a water hose.

4. The method of claim 3, wherein controlling the pressure of the inflatable bag via the liquid-based pressure control system comprises controlling the pressure of the inflatable bag by adjusting a height of water in the water column.

5. The method of claim 1, wherein the wing is anchored to a testing fixture during the wing bend test.

6. The method of claim 1, wherein the wing is attached to a vehicle during the wing bend test.

7. The method of claim 1, wherein the upward force applied by the plurality of inflatable bags on the wing comprises an evenly distributed upward force.

8. The method of claim 1, wherein the upward force applied by the plurality of inflatable bags on the wing comprises an unevenly distributed upward force that simulates an elliptical load distribution that the wing is likely to experience during operation.

9. The method of claim 1, wherein the one or more measurement tools comprise at least one of (i) a plurality of scales positioned beneath the plurality of inflatable bags, wherein each of the plurality of scales is configured to measure a total vertical force exerted by a corresponding one of the plurality of inflatable bags, (ii) a set of load pins coupling the wing to a testing fixture or a vehicle, or (iii) a set of load cells.

10. The method of claim 1, wherein an interface layer comprising a soft layer and a rigid layer is positioned between each of the plurality of inflatable bags and the wing.

11. The method of claim 1, wherein the one or more measurement tools comprise a fiber optic strain sensor (FOSS), the method further comprising:
utilizing the FOSS to measure strain along a length of the wing.

12. The method of claim 1, wherein the pressure control system comprises a plurality of safety relief valves, the method further comprising:
implementing the plurality of safety relief valves to present over-pressurization of the plurality of inflatable bags.

13. The method of claim 1, wherein the wing bend test comprises at least one of (i) a static wing bend test or (ii) a dynamic fatigue test.

14. The method of claim 1, further comprising utilizing a graphical user interface (GUI) system to present, via a display of the GUI system, real-time force measurements from at least one measurement tool, wherein the GUI system is communicatively coupled to the at least one measurement tool.

15. An apparatus for performing a wing bend test on a vehicle wing, the apparatus comprising:
a test fixture configured to secure the wing;
a plurality of inflatable bags configured to be positioned beneath an underside of the wing;
one or more measurement tools for measuring one or more parameters of the wing bend test, wherein at least one of the one or more parameters comprises an upward force applied by the plurality of inflatable bags on the wing;
a pressure control system configured to control pressure within the plurality of inflatable bags;
a graphical user interface (GUI) system communicatively coupled to the one or more measurement tools, wherein the GUI system is configured to receive real-time force measurements from at least one measurement tool and display the real-time force measurements.

16. The apparatus of claim 15, wherein the test fixture includes a plurality of concrete barriers to secure the wing.

17. The apparatus of claim 15, further comprising at least one of (i) a fiber optic strain sensor (FOSS) configured to be installed on the wing to measure strain of the wing or (ii) at least one load pin configured to connect the wing to the testing fixture and measure vertical reaction forces.

18. The apparatus of claim 15, further comprising an interface layer comprising (i) a soft layer and (ii) a rigid layer, wherein the interface layer is positioned between each of the plurality of inflatable bags and the underside of the wing.

19. The apparatus of claim 15, wherein the pressure control system comprises (i) an air-based pressure control system including an air manifold and a plurality of gate valves, wherein each of the plurality of gate valves is configured to control an air pressure for a respective one of the plurality of inflatable bags or (ii) a liquid-based pressure control system including a water column connected to the inflatable bag via a water hose, wherein the liquid-based pressure control system is configured to control the pressure of the plurality of inflatable bags by adjusting a height of water in the water column.

20. The apparatus of claim 15, wherein the upward force applied by the plurality of inflatable bags on the wing comprises (i) an evenly distributed upward force or (ii) an unevenly distributed upward force that simulates an elliptical load distribution that the wing is configured to experience during operation.
